(19) United States
(12) Patent Application Publication
(10) Pub. No.: US 2004/0135045 A1
(43) Pub. Date: Jul. 15, 2004

(54) Unaligned multiple-column height adjustable pedestals for tables and chairs that tilt and slide

(76) Inventor: John E. Larson, Hamilton, MT (US)

Correspondence Address: Jean Kyle, Saliwanchik, Lloyd & Saliwanchik, P.O. Box 2274, Hamilton, MT, 59840-4274, US

(21) Appl. No.: 10/736,804

(22) Filed: Dec. 15, 2003

Related U.S. Application Data
(63) Continuation of application No. 10/005,002, filed on Dec. 3, 2001, now abandoned.
(60) Provisional application No. 60/250,260, filed on Dec. 1, 2000.
(60) Provisional application No. 60/251,058, filed on Dec. 1, 2000.

(51) Int. Cl. F16M 11/20

(52) U.S. Cl. 248/188.1

(57) ABSTRACT

A height adjustable pedestal having two or more height adjustable telescoping columns can be raised or lowered freely without binding. The telescoping columns engage a furniture component through at least two pivots and at least one slider. Pivotal and sliding engagement of the furniture component with the telescoping columns allows the furniture component to slide and pivot freely over the column precluding axial misalignment of the telescoping members of the columns due to non-parallelity between columns, or misalignment caused by columns moving at disparate speeds. Engagement of the furniture component in this manner also allows the telescoping columns to be adjusted independently of one another providing, for example, a tiltable table top or chair seat. Further, the table top or chair seat can slide in relationship to the height adjustable telescoping columns.

### CROSSREFERENCE TO RELATED APPLICATIONS

This application is based on provisional application Serial No. 60/250,260, filed Dec. 1, 2000 and provisional application Serial No. 60/251,058, filed Dec. 1, 2000. The disclosures of these applications are hereby incorporated by reference in their entirety, including all figures, tables and drawings.

### BACKGROUND OF THE INVENTION

With the increasing popularity of ergonomic design, the demand for height adjustable furniture has skyrocketed. Ergonomics define the orientation between humans and machines which encourages a comfortable, productive relationship. Chairs should be adjusted so a seated worker's feet are flat on the ground to reduce strain on the lower back. Repetitive injuries, such as carpal tunnel syndrome, can be avoided using adjustable keyboard platforms to vary the position of the keyboard and thus ease strain on the wrists. Ergonomic positioning reduces strain on the body and therefore ameliorates fatigue and possible injury. Office workers come in all shapes and sizes however, thus office chairs and tables must be adjustable to accommodate a worker who is five foot two as well as a co-worker who is six feet four.

In most cases, height adjustment is achieved utilizing height adjustable pedestals. Pedestals often comprise telescoping columns to achieve height adjustment. These columns have telescoping tubes which slide one inside the other as column height is adjusted. Height adjustable telescoping columns are well known in the art and can be driven by electro-mechanical drive mechanisms, piezoelectric drive mechanisms (U.S. Pat. No. 5,568,004). electromagnetic drive mechanisms (U.S. Pat. No. 5,440,183), hydraulic drive mechanisms (U.S. Pat. No. 5,553,550), pneumatic drive mechanisms (U.S. Pat. Nos. 5,437,236 and 4,934,723), mechanical drive mechanisms, and spring drive mechanisms (U.S. Pat. No. 5,078,351 and U.S. Pat. No. 6,182,583 B1). A problem experienced by all telescoping mechanisms is binding of the telescoping members as they slide one into or out of the other.

Binding occurs when the telescoping members of a column are not in axial alignment. For telescopes to function, the forces for extending or retracting the slidable members in relationship to each other must be directed axially on the slidable members. Any sideways forces acting on one or both of the telescoping members forces one slidable telescoping member out of axial alignment with another telescoping member which causes portions of one telescoping member to be forced into the slidable surface of another telescoping member of the telescoping column. This causes frictional engagement between the telescoping members and reduces or cancels the slidable relationship that defines a telescope.

Off center loading of a telescoping column produces a sideways force on the telescoping column, as for instance, when a single telescoping column is vertically centered under a large diameter tabletop and a person sits on the edge of the tabletop at a distance away from the column. The downward force of the person's weight at a lateral distance away from the top center, or axis, of the telescope forces a bending moment on the slidable members of the telescope. Because the column has separate vertically sliding members, a portion of one member is forced sideways into a portion of another member effecting a frictional “welding” of the two telescoping members. The two members will be jammed together and prevented from having a sliding relationship with each other.

Using more than one telescoping column to support a tabletop can, on the one hand, distribute the load among columns thus dissipating the concentrated sideways forces acting on each column, as for instance in the case of four columns positioned for the vertical support of a table at the four corners of the table. On the other hand, the use of more than one telescoping column requires a parallel relationship between or among the columns or at least axial alignment between or among the sliding members of each of the multiple columns. Multiple telescoping columns used to raise or lower a tabletop in relationship to the floor supporting the multiple columns, require close tolerances for parallel relationships between or among the telescoping members of each column and between or among the telescoping columns in relationship to each other. These close tolerances are difficult and expensive to achieve with most current manufacturing capabilities. For instance, when lower cross supports connecting the lower stationary members of the telescoping columns are welded, the heating and cooling of the metal components of the supports and the telescoping members pull the telescoping members of the column out of a vertical, or parallel alignment in relationship to each other and to the columns. The skewed columns are no longer plumb between the tabletop and the floor. When multiple telescoping columns are rigidly fastened between a tabletop and base, and not parallel with each other, all of the telescoping members of all of the telescoping columns are subjected to conflicting sideways forces. The forces act quantitatively accumulating friction that causes binding or all out jamming during any attempted height adjustment of the pedestal or table. Crooked telescoping columns rigidly fastened between a tabletop and base will not extend or contract without a force strong enough to overcome the accumulated frictions of the telescoping members.

Sideways forces acting on telescoping columns also occur when one telescoping column extends or contracts at a greater speed or with greater force than another telescoping column when two or more columns are rigidly attached between a tabletop and a base. In this instance, when a first parallel telescoping column is forced to a higher elevation than a second telescoping column parallel to the first, the columns attempt to angle and travel away from each other in relationship to their contact points on either the tabletop or the base supporting the columns. Either the tabletop or the base attempts to angle and move bi-directionally between the two telescoping columns to compensate for the differing distances occurring from angling between the more extended column and the less extended column. Because of the rigid attachments of the upper and lower ends of the columns to the tabletop and base, neither the tabletop nor the base can pivot or slide laterally from the ends of the rigidly attached columns which are rigidly attached in a fixed lateral distance along the tabletop or base. Without the tabletop or base being able to slide and pivot over the ends of the columns to compensate for the greater angular distances of the columns in relationship to the upper or lower fastening points of the tabletop or base, a sideways force is exerted against the telescoping members of the telescoping columns and the telescoping columns are prevented from extending or contracting. One solution for a problem similar to this is described in U.S. Pat. No. 6,286,441 B1 for electro-mechanical driven cantilever assemblies. This patent utilizes an electronic sensor to sense the differing speeds and heights of extending or contracting tabletop ends driven by separate electric motors for each end of the tabletop. The sensor is a component that allows for effecting a reduction in power to the motor that is raising or lowering the faster or higher end of the tabletop. If this strategy were applied to the motors powering electro-mechanical telescoping columns, sideways forces exerted on the telescoping members of the columns would be eliminated by keeping the tabletop in a non-angling, perpendicular relationship to the parallel height adjustable columns.

There are no perfectly parallel telescoping columns. To one degree or another, multiple telescoping columns are off-parallel in relationship to each other. Zero tolerance is rarely, if ever, achieved or maintained.

One solution that is routinely used to overcome the frictional binding of multiple telescoping column is to increase the power used to move the slidable members of the columns past each other. For example, in the case of using electric motors, a more powerful motor can be used to force the binding telescoping members past each other. When force is used to overcome this binding friction, the components of the column are subjected to stresses that shorten the life of the column and also shorten the life of the chair or table it supports. Increasing the power to use a force strategy to overcome frictional binding is not applicable when the telescoping columns are, for example, gas springs. A gas spring supported table derives its lifting force from gas springs with a substantially finite power supply. Any additional power required to overcome frictional binding of the telescoping components of gas springs would have to come from the table user, and that power source is dependent upon the physical condition of the user.

Previous attempts to reduce binding among multiple telescoping columns have involved the use of flexible, longitudinally moving assemblies to allow each column to laterally flex-adjust to sideways forces in relationship to the telescoping members. Another strategy is to use multiple concentric telescoping components with low friction bearing assemblies as guides (U.S. Pat. No. 5,553,550). Intricate methods of expanding and contracting bearing surfaces allow lateral and pivotal movement in a low friction lateral “give” system which, like the flex system just mentioned, permits the telescoping column members to remain in axial alignment by way of the slight lateral movement and slight indirect pivoting inside the rigidly attached guide column to the tabletop and base in relationship to the telescoping members. In effect, the flexible column guides allow the telescoping members to move into alignment when struck with any sideways forces directed against the column in order to protect the telescoping members from having the sideways forces act adversely upon them. These strategies of allowing the telescoping members to have a controlled laterally angling relationship with the column guides is necessary to compensate for a degree of imperfect parallel alignment between or among telescoping columns which are rigidly fastened via a table top or base at both ends.

Preventing binding of telescoping columns has involved complicated braces and intricate guide systems running longitudinally along the telescoping members. These braces and guide systems are an integral part of the telescoping column. These braces and guide systems allow lateral freedom of movement and a slight pivoting of telescoping guides in columns that are rigidly attached at both ends, for instance to a tabletop and a base, where no lateral movement or pivoting is possible. Without this lateral freedom of movement, not only between telescoping members and their respective column guides, but also between the telescoping members of one column in relationship to the telescoping members of another column, the result would be telescoping members forced into axially unaligned non-parallel relationships that would prevent telescoping of the members. The telescoping columns would then jam and be prevented from being extended or retracted. Another strategy for allowing lateral and pivotal freedom is shown in U.S. Pat. No. 5,433,409. A flexible plastic maze structure is positioned in a stand tube which vertically supports a telescoping gas spring. The maze allows lateral movement for self adjustment and maintenance of an axial relationship between the telescoping members of a gas spring as sideways forces are exerted against the guides. In addition, this vertical flexible column assembly is part of a one-piece plastic structure having a laterally supporting plastic base. The use of plastic in this support structure for telescoping members flexibly allows lateral and pivotal movement for the telescoping members to self adjust or maintain their parallel relationship when sideways forces are exerted toward them from off-center loading on the column.

Telescoping members of telescoping columns must maintain axial alignment to function. Insuring axial alignment of the telescoping members during telescoping movement has involved adding guide systems and braces to the telescoping columns. It should be mentioned that with very loose fitting telescoping guides, the telescoping members are allowed ample freedom to self adjust to parallel alignment of the members, the drawback being that the pedestal, table or chair supported in this manner wobbles and weaves. When this freedom is reduced to a tight fitting guide system for the telescoping members, the telescoping members bind and jam. From the foregoing, it is apparent, that a need remains for a method that insures that furniture having height adjustable columns are not plagued by binding.

All patents, patent applications, provisional patent applications and publications referred to or cited herein, or from which a claim for benefit of priority has been made, are incorporated by reference in their entity to the extent they are not inconsistent with the explicit teachings of the specification.

### SUMMARY OF THE INVENTION

The invention involves height adjustable pedestals which are not subject to binding. The pedestals comprise at least two height adjustable telescoping columns. The columns pivotally engage a furniture component through a furniture support mechanism. The furniture support mechanism comprises at least three furniture support assemblies providing at least two pivots and at least one sliding mechanism. Height adjustable columns engaging a furniture component through these mechanisms can be non-parallel to one another beneath the furniture component yet remain fully functional for height adjustment. The subject pedestal not only allows height adjustable columns in the pedestal to remain functional if non-parallel, but also advantageously allows each column to be raised or lowered independently providing a tiltable table surface or chair seat.

### BRIEF DESCRIPTION OF THE FIGURES

FIG. 1 is a top plan view of a height adjustable table with four unaligned telescoping columns.

FIG. 2 is a side elevational view of a preferred embodiment of a two-column height adjustable pedestal of the subject invention where the furniture component is a table top.

FIG. 3 is a side elevational view of a preferred embodiment of a two-column height adjustable pedestal of the subject invention where the furniture component is a table top.

FIG. 4 is a side elevational view of a preferred embodiment of a two-column height adjustable pedestal of the subject invention where the furniture component is a table top.

FIG. 5 is a side elevational view of a preferred embodiment of a two-column height adjustable pedestal of the subject invention where the furniture component is a table top.

FIG. 6 is a side elevational view of a preferred embodiment of a two-column height adjustable pedestal of the subject invention where the furniture component is a table top.

FIG. 7 is a side elevational view of a preferred embodiment of a four-column height adjustable pedestal of the subject invention where the furniture component is a table top.

FIG. 8 is a side elevational view of another preferred embodiment of a four-column height adjustable pedestal of the subject invention where the furniture component is a table top.

FIG. 9 is side elevational view of another preferred embodiment of a two-column height adjustable pedestal of the subject invention where the furniture component is a table top.

FIG. 10 is a perspective view of a preferred embodiment of a pivoting furniture support mechanism of a height adjustable pedestal of the subject invention.

FIG. 11 is a top plan view of the pivoting furniture support mechanism shown in FIG. 10.

FIG. 12 is a side elevational view of the pivoting furniture support mechanism shown in FIG. 10.

FIG. 13A is a side elevational view of another preferred embodiment of a pivoting furniture support mechanism of a height adjustable pedestal of the subject invention.

FIG. 13B is a side elevational view of the pivoting furniture support mechanism shown in FIG. 13A.

FIG. 14A is a side elevational view of another preferred embodiment of a pivoting furniture support mechanism of a height adjustable pedestal of the subject invention.

FIG. 14B is a side elevational view of the pivoting furniture support mechanism shown in FIG. 14A.

FIG. 15A is a side elevational view of another preferred embodiment of a pivoting furniture support mechanism of a height adjustable pedestal of the subject invention.

FIG. 15B is a side elevational view of the pivoting furniture support mechanism shown in FIG. 15A.

FIG. 16 is a perspective view of a preferred embodiment of a sliding furniture support mechanism of a height adjustable pedestal of the subject invention.

FIG. 17 is a top plan view of the sliding furniture support mechanism shown in FIG. 16.

FIG. 18 is a side elevational view of the sliding furniture support mechanism shown in FIG. 16.

FIG. 19 is a perspective view of another preferred embodiment of a sliding furniture support mechanism of a height adjustable pedestal of the subject invention.

FIG. 20 is a side elevational view of the sliding furniture support mechanism shown in FIG. 19.

FIG. 21 is a side elevational view of the sliding furniture support mechanism shown in FIG. 19.

FIG. 22 is a perspective view of another preferred embodiment of a sliding furniture support mechanism of a height adjustable pedestal of the subject invention.

FIG. 23 is a top plan view of the sliding furniture support mechanism shown in FIG. 22.

FIG. 24 is a side elevational view of the sliding furniture support mechanism shown in FIG. 22.

FIG. 25 is a top plan view of another preferred embodiment of a sliding furniture support mechanism of a height adjustable pedestal of the subject invention.

FIG. 26 is a side elevational view of the sliding furniture support mechanism shown in FIG. 25.

FIG. 27 is an end view of the sliding furniture support mechanism shown in FIG. 25.

FIG. 28 is a side elevational view of another preferred embodiment of a sliding furniture support mechanism of a height adjustable pedestal of the subject invention.

FIG. 29 is a side elevational view of another preferred embodiment of a sliding furniture support mechanism of a height adjustable pedestal of the subject invention.

FIG. 30A is a side elevational view of another preferred embodiment of a sliding furniture support mechanism of a height adjustable pedestal of the subject invention.

FIG. 30B is a side elevational view of the sliding furniture support mechanism shown in FIG. 30A.

FIG. 31 is a side elevational view of another preferred embodiment of a sliding furniture support mechanism of a height adjustable pedestal of the subject invention.

FIG. 32 is a top plan view of another preferred embodiment of a two-column height adjustable pedestal of the subject invention.

FIG. 33 is a top plan view of another preferred embodiment of a two-column height adjustable pedestal of the subject invention.

FIG. 34 is a top plan view of another preferred embodiment of a two-column height adjustable pedestal of the subject invention.

FIG. 35 is a top plan view of another preferred embodiment of a two-column height adjustable pedestal of the subject invention.

FIG. 36 is a top plan view of another preferred embodiment of a two-column height adjustable pedestal of the subject invention.

FIG. 37 is a top plan view of another preferred embodiment of a two-column height adjustable pedestal of the subject invention.

FIG. 38 is a top plan view of another preferred embodiment of a two-column height adjustable pedestal of the subject invention.

FIG. 39 is a top plan view of another preferred embodiment of a two-column height adjustable pedestal of the subject invention.

FIG. 40 is a top plan view of another preferred embodiment of a two-column height adjustable pedestal of the subject invention.

FIG. 41 is a top plan view of a preferred embodiment of a three-column height adjustable pedestal of the subject invention.

FIG. 42 is a top plan view of another preferred embodiment of a three-column height adjustable pedestal of the subject invention.

FIG. 43 is a top plan view of another preferred embodiment of a three-column height adjustable pedestal of the subject invention.

FIG. 44 is a top plan view of another preferred embodiment of a three-column height adjustable pedestal of the subject invention.

FIG. 45 is a top plan view of another preferred embodiment of a three-column height adjustable pedestal of the subject invention.

FIG. 46 is a top plan view of another preferred embodiment of a three-column height adjustable pedestal of the subject invention.

FIG. 47 is a top plan view of another preferred embodiment of a three-column height adjustable pedestal of the subject invention.

FIG. 48 is a top plan view of another preferred embodiment of a three-column height adjustable pedestal of the subject invention.

FIG. 49 is a top plan view of another preferred embodiment of a three-column height adjustable pedestal of the subject invention.

FIG. 50 is a top plan view of another preferred embodiment of a four-column height adjustable pedestal of the subject invention.

FIG. 51 is a top plan view of another preferred embodiment of a four-column height adjustable pedestal of the subject invention.

FIG. 52 is a top plan view of another preferred embodiment of a four-column height adjustable pedestal of the subject invention.

FIG. 53 is a top plan view of another preferred embodiment of a four-column height adjustable pedestal of the subject invention.

FIG. 54 is a top plan view of another preferred embodiment of a four-column height adjustable pedestal of the subject invention.

FIG. 55 is a top plan view of another preferred embodiment of a four-column height adjustable pedestal of the subject invention.

FIG. 56 is a top plan view of another preferred embodiment of a four-column height adjustable pedestal of the subject invention.

FIG. 57 is a top plan view of another preferred embodiment of a four-column height adjustable pedestal of the subject invention.

FIG. 58 is a top plan view of another preferred embodiment of a four-column height adjustable pedestal of the subject invention.

FIG. 59 is a top plan view of another preferred embodiment of a four-column height adjustable pedestal of the subject invention.

FIG. 60 is an exploded view of a preferred embodiment of a furniture support mechanism of a height adjustable pedestal of the subject invention.

FIG. 61 is an exploded view of a preferred embodiment of a furniture support mechanism of a height adjustable pedestal of the subject invention.

FIG. 62 is an exploded view of a preferred embodiment of a furniture support mechanism of a height adjustable pedestal of the subject invention.

FIG. 63 is a side elevational view of an electric height adjustable telescoping column for use in a height adjustable pedestal of the subject invention.

FIG. 64 is a perspective view of another preferred embodiment of a height adjustable pedestal of the subject invention where the furniture component is a table top.

FIG. 65 is a perspective view of another preferred embodiment of a height adjustable pedestal of the subject invention where the furniture component is a table top.

FIG. 66A is a side elevational view of a preferred embodiment of a height adjustable pedestal of the subject invention where the furniture component is a chair seat.

FIG. 66B is a top plan view of the swivel mechanism of the pedestal shown in FIG. 66A.

FIG. 67A is a side elevational view of another preferred embodiment of a height adjustable pedestal of the subject invention where the furniture component is a chair seat.

FIG. 67B is a front elevational view of the height adjustable pedestal shown in FIG. 67A.

FIG. 68A is a side elevational view of another preferred embodiment of a height adjustable pedestal of the subject invention where the furniture component is a chair seat.

FIG. 68B is a front elevational view of the height adjustable pedestal shown in FIG. 68A.

FIG. 69A is a side elevational view of another preferred embodiment of a height adjustable pedestal of the subject invention where the furniture component is a chair seat.

FIG. 69B is a front elevational view of the height adjustable pedestal shown in FIG. 69A.

FIG. 70A is a side elevational view of another preferred embodiment of a height adjustable pedestal of the subject invention where the furniture component is a chair seat.

FIG. 70B is a top plan view of the swivel mechanism of the pedestal shown in FIG. 70A.

FIG. 71 is a side elevational view of a preferred embodiment of a height adjustable pedestal of the subject invention where the first and second furniture component are table tops.

FIG. 72 is a side elevational view of another preferred embodiment of a height adjustable pedestal of the subject invention where the first and second furniture components are table tops.

### DETAILED DESCRIPTION OF THE INVENTION

The subject invention involves a height adjustable pedestal for furniture. Height adjustable chairs and tables using pedestals according to the subject invention do not suffer from binding. Height adjustable telescoping columns within the subject pedestals engage a furniture component through a furniture support mechanism that slides and pivots. The furniture support mechanism allows the furniture component to move relative to the height adjustable telescoping columns eliminating any sideways forces from acting on the telescoping columns that would ordinarily cause the columns to bind.

Height adjustment within the subject pedestals is achieved using telescoping columns. Telescoping columns include at least a first tube into which inner rods or tubes move axially in relationship to the first tube. The inner tubes or rods have an outer diameter smaller than the inner diameter of the tube in which they move. The inner rods or tubes move axially in relationship to the outer tube when the column is extended or retracted. Height adjustable telescoping columns are extended in length to raise a furniture component from the floor and retracted to a lesser length to lower the furniture component toward the floor.

Telescoping columns can be internally or externally driven. For example, telescoping columns can be extended by a spring mechanism, or extended or retracted by utilizing hydraulic or pneumatic systems. Likewise, telescoping columns can be driven to extend or retract using electric motors to turn gears or screws, or be hand cranked mechanically to turn gears or screws. Sometimes electric motors are used to pump the hydraulic fluid instead of a mechanical hand crank pump. Sometimes electric motors are used to turn a mechanical crank system. Pneumatic systems can consist of a sealed contained pressurized gas that drives in only one direction, such as a gas spring, to either extend or contract a column; or consist of a system where air is pumped into the telescoping column or columns to extend one member away from another for extension, and allow the air to exit the column to retract one member back towards the other member for retraction of the column. A metal coil spring can also be used to drive a telescoping member in one direction. Any of these basic drive systems can be combined for one to operate another.

Telescoping columns as well as their drive mechanisms, are well known in the art. Briefly, spring type telescoping mechanisms can include gas springs and metal coil springs. A metal coil type spring is shown in U.S. Pat. No. 5,078,351. This spring includes an oil dampening mechanism. Gas springs have a gas cylinder filled with a pressurized gas such as nitrogen. A piston or rod extends from the cylinder. Movement of pressurized gas within the cylinder drives the piston from the cylinder.

Hydraulic telescoping columns have a sealed fluid moving to or from a fluid reservoir to the column to push or pull one telescoping member toward or away from another telescoping member. Electric motors or mechanical hand cranks are commonly used to pump the sealed fluid.

Electric motor driven telescoping columns can be controlled by switches conveniently placed for the user. A wireless remote switch can be used to actuate the electric motors for up, down or stop movement of the column or columns, and can also control the speed of the motors and thus the columns. Electric motors can be positioned internally within each column or be positioned on the pedestal outside the columns to drive one or more columns. As with springs, electric motors provide force and are the force component of the drive mechanism. For an electrically driven column to move, however, the motor must be connected to some other drive component, such as a ball screw, worm gear, sprocket and chain, hydraulic pump or air pump to force the telescoping members to move in relationship to each other. The subject height adjustable pedestals utilize two or more telescoping columns. Applicant notes, telescoping columns are well known and those skilled in the art would be aware of the types of columns, drive mechanisms and actuation or control systems applicable to the pedestals of the subject invention.

To function, the telescoping members within a telescoping column must be axially aligned with one another to slide freely past one another. Axial alignment of the telescoping members can be compromised by any sideways force acting on either of the telescoping members.

The pedestals of the subject invention comprise a furniture component that pivotally and slidably engages at least two telescoping columns. The furniture component is able to pivot and slide in relationship to the columns thus eliminating any sideways force from acting on the telescoping members of the height adjustable telescoping columns as a result of off center loading on the columns, or having the columns in non-parallel alignment with each other, or having one column extend higher or faster than another column. The sideways forces that normally plague conventional multiple column height adjustable columns due to their rigid, fixed connection to the furniture component, are eliminated from the subject invention because each column is slidable and pivotally engaged in their relationship to each other and the furniture component. The result of this slidable, pivotal relationship of the columns to the furniture component is that the columns of the subject invention are never pulled or pushed by the furniture component. If the furniture component were rigidly fixed to the furniture component, a non parallel alignment of one column to another would cause one column to push or pull the furniture component toward or away from another column as the columns extended or retracted. The rigid connections of these columns to the furniture component causes non-parallel columns to create sideways forces that act on both columns as they extend or contract. Sideways forces that cause binding and jamming of the telescoping members of the height adjustable telescoping columns of conventional pedestals increase in direct proportion to the degree in which the columns are off parallel with each other. These sideways forces do not exist in the subject invention.

The pedestals of the subject invention comprise a floor contacting base having at least two sections. The base supports at least two height adjustable telescoping columns. Above the telescoping columns is a furniture support mechanism that supports a furniture component. The furniture support mechanism comprises at least three furniture support assemblies, at least two of which pivot and at least one of which slides. The furniture support mechanism thus allows the furniture component to pivot and slide in relationship to the height adjustable telescoping columns rather than be rigidly fixed to the columns. In this way, the furniture component never exerts a lateral force to the columns. All forces of the subject pedestal are confined to the extension or retraction of the telescoping columns upwardly or downwardly which result in raising or lowering the furniture component relative to the floor.

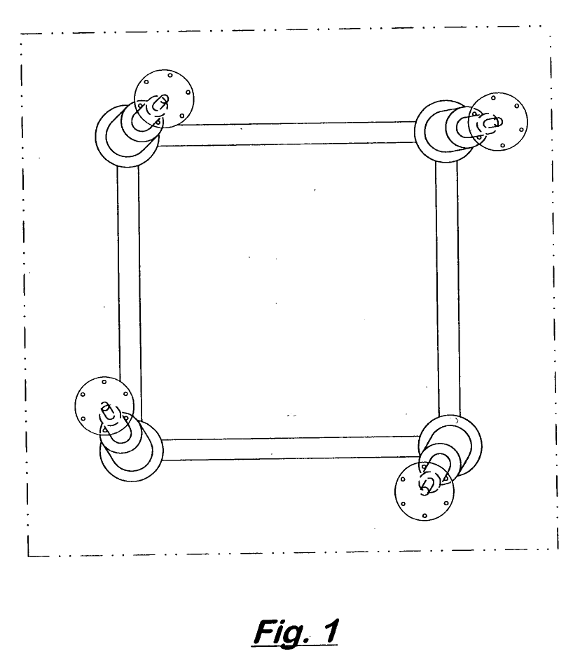

FIG. 1 shows a table with multiple telescoping columns. The figure exaggerates the non-parallel relationship of the columns to illustrate the problem of misaligned columns. Conventional tables made for market would never have this degree of misalignment because with the rigid fastening of the columns to the tabletop as shown in the figure, height adjustability would be impossible. Here it is illustrated that any two columns can be out of parallel with one another in two directions per column. The addition of two more columns, each also having parallel misalignment in two directions, multiplies the possibilities of relational misalignment among columns as the number of columns is increased.

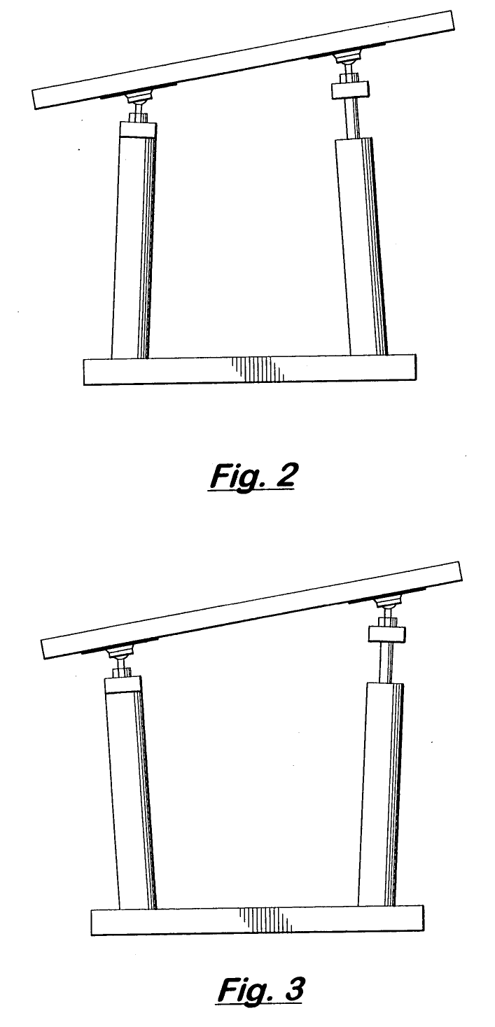

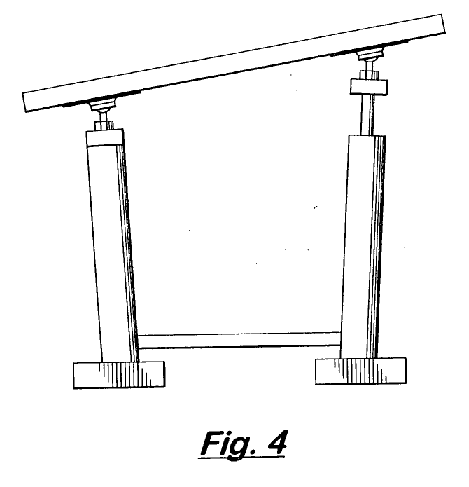

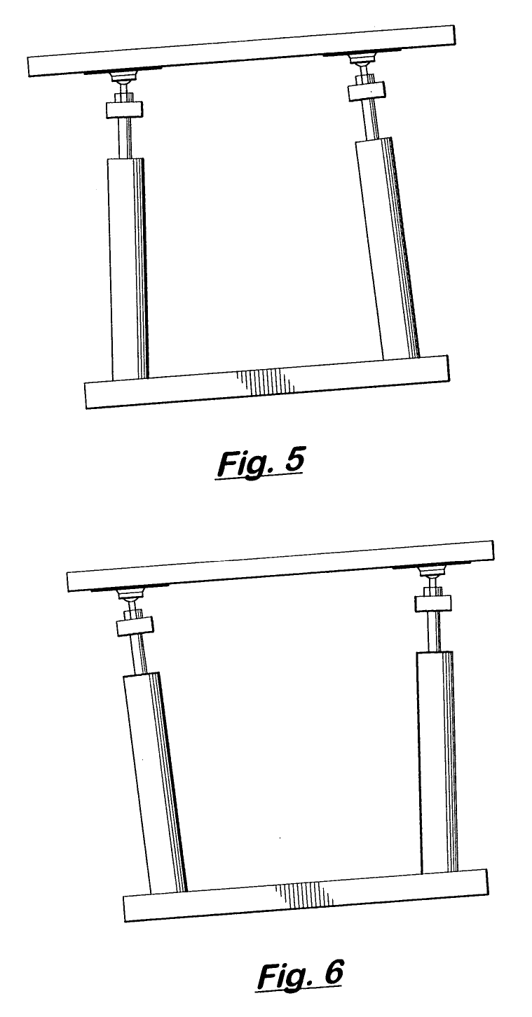

FIGS. 2-4 show height adjustable pedestals of the subject invention as the pivoting and sliding furniture support mechanism is shown positioned between the furniture component and two height adjustable telescoping columns for pivotal and slidable engagement of the furniture component to the height adjustable telescoping columns. These figures exaggerate the non-parallel relationship of the columns to illustrate the degree to which the columns can be misaligned and still be height adjustable with no binding. The figures further illustrate that the columns can be extended or contracted independently of one another by showing that the furniture component, in this case a tabletop, can be tilted. FIGS. 5 and 6 show however that the furniture component need not be tilted. In this instance, a height adjustable table with a horizontal work surface is produced by raising or lowering the columns concurrently, or by raising one column independently of the other to a height that levels the tabletop in a horizontal plane parallel to the floor. When one column is moving independently of the other column, it is moving faster than the other column since the other column need not be moving at all.

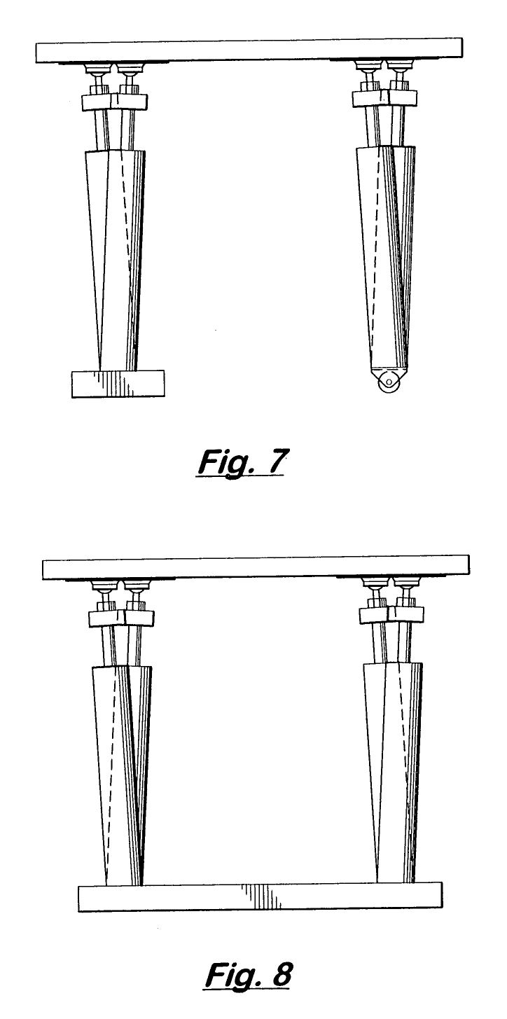

FIGS. 7 and 8 show a height adjustable pedestal of the subject invention which has four telescoping columns. As noted previously, the four columns have numerous ways in which they can be out of alignment. In the subject pedestals however, the columns do not bind because the furniture component is pivotally and slidably engaged to the columns rather than being rigidly affixed to the columns.

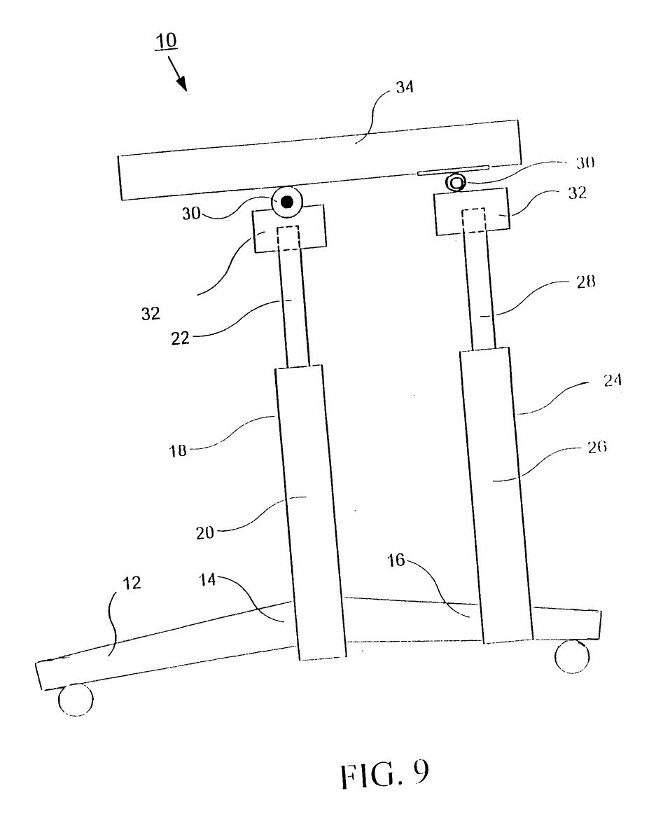

A preferred embodiment of a height adjustable pedestal of the subject invention is shown generally at 10 in FIG. 9. The pedestal comprises a floor contacting base 12. The base comprises at least first base section 14 and a second base section 16. The first base section 14 supports a first height adjustable column 18 which extends vertically therefrom. The column 18 has a lower section 20 attached to the first base section 14. An upper section 22 moves upwardly or downwardly relative to the lower section 20. A second height adjustable column 24 has a lower section 26 and an upper section 28. The upper section 28 moves upwardly or downwardly in relationship to the lower section 26. A furniture support mechanism 30 comprises a first, second and third furniture support assembly. The furniture support mechanism is disposed above all telescoping height adjustable columns. The first furniture support assembly of the furniture support mechanism comprises at least a first pivoting furniture support mechanism which includes a pivot. The second furniture support assembly comprises at least a first pivoting furniture support mechanism which also includes a pivot. The third furniture support assembly comprises at least a first sliding furniture support mechanism. In this embodiment, the furniture support mechanism 30 is connected to the upper portions, 22 and 28 of columns 18 and 24, respectively, by attachment blocks 32. It is noted however that the furniture support mechanism 30 can be attached directly to the columns. The height adjustable pedestal of the subject invention further comprises a furniture component. In this embodiment, the furniture component is a tabletop. The furniture component 34 is disposed above and is pivotally and slidably supported by the furniture support mechanism 30. In this embodiment, only one of the pivots of the furniture support mechanism 30 is attached to the furniture component

The multi-column height adjustable pedestal of the subject invention functions without binding because the furniture support mechanism allows the furniture component to pivot and slide in relationship to the height adjustable telescoping column. The pivotal and lateral movement of the furniture component in relationship to the height adjustable telescoping columns prevents the generation of lateral forces acting on the height adjustable telescoping columns that would cause binding. The first and second furniture support assemblies of the furniture support mechanisms of the pedestals of the subject invention comprise at least one pivoting furniture support mechanism. The third furniture support assembly comprises at least one sliding furniture support mechanism. Multiple-column pedestals of the subject invention must have at least two pivots and at least one slider. The simple hinge disposed above column 24 in FIG. 9 is one pivot. The roller above column 18 is a second pivot and a slider that allows the furniture component to pivot and slide over it. The furniture component, in this case, tabletop 34 can pivot about the roller as its under-surface slides over the roller.

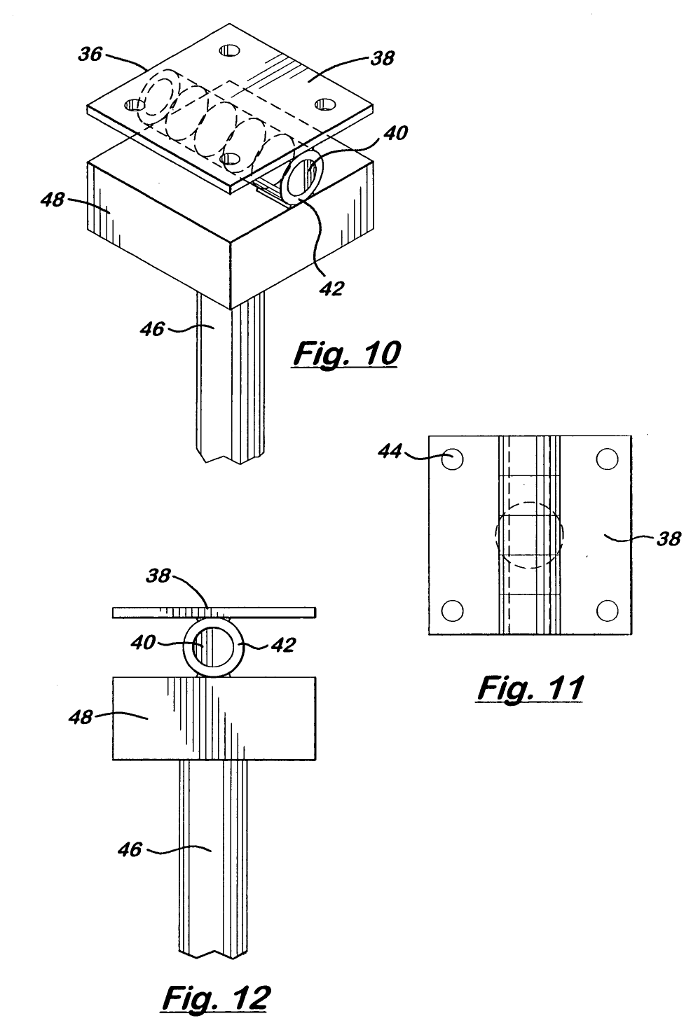

FIGS. 10-12 show a pivoting furniture support mechanism 36 which is part of a furniture support assembly. The mechanism is a simple hinge comprising a plate 38, a pin or pivot 40, and a barrel 42. The hinge is configured to be fixedly attached to another unit using the holes 44 on the plate 38. The hinge can be attached to the furniture component, a telescoping column, or to other pivoting and/or sliding furniture support mechanisms. In this embodiment, the assembly is welded to an attachment block 48 which is connected to a telescoping column 46. This simple hinge allows for bi-directional pivot rocking only back and forth above the pivot.

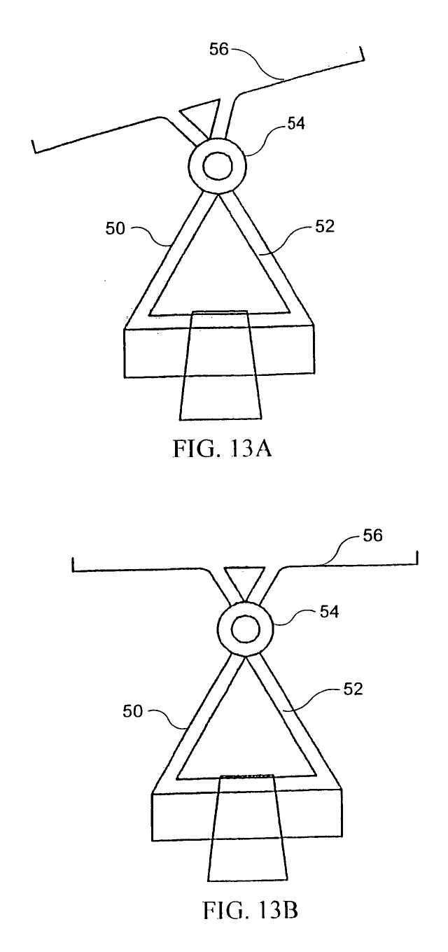

FIGS. 13A and 13B show another preferred embodiment of a pivoting furniture support mechanism 50. The mechanism comprises a base 52, a pivot 54, and a support 56. The support 56 can be attached to a furniture component, a telescoping column, or other pivoting and/or sliding furniture support mechanisms. Alternatively, the support 56 can slideably engage the under-surface of a furniture component to act as a slide. This furniture support mechanism allows for bi-directional pivoting.

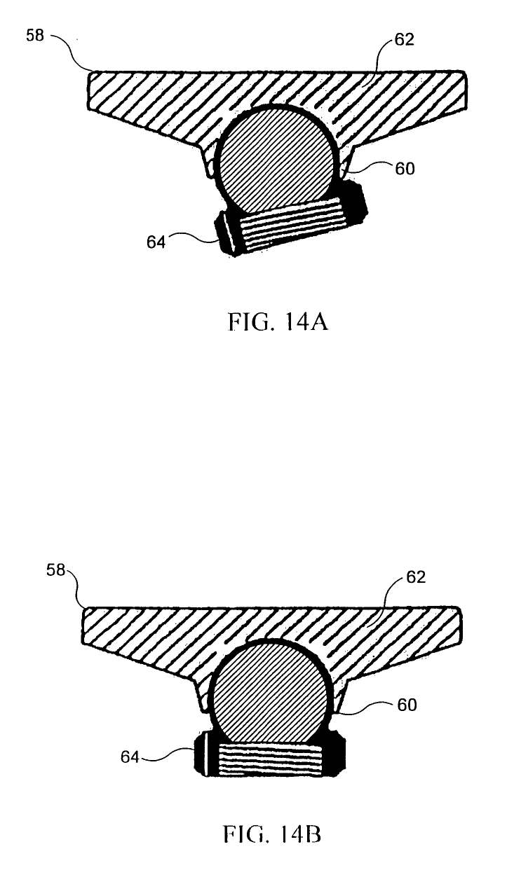

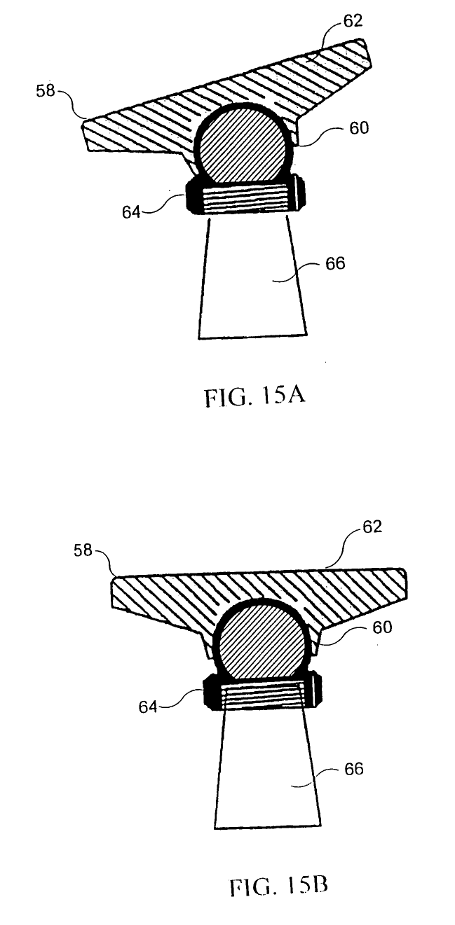

FIGS. 14A and 14B show another preferred embodiment of a pivoting furniture support mechanism 58. The mechanism is a simple ball and socket comprising a ball 60, and a socket 62. The socket 62 has a plate-like surface. The surface can be fixedly or slidably attached to a furniture component, a telescoping column, or other pivoting and/or sliding furniture support mechanisms. Alternatively, the surface can slideably engage the under-surface of a furniture component to a act as a slide. The ball 60 of the subject mechanism has an end cap 64 that is internally threaded for connection to, for example, a telescoping column 66 (see FIGS. 15A and 15B). The mechanism can likewise be connected to other pivoting and/or sliding furniture support mechanisms in this manner. This furniture support mechanism is an omni-directional pivot, pivoting in any direction.

FIGS. 16-18 show another preferred embodiment of a furniture support assembly 68 comprising a pivoting furniture support mechanism 70 and a sliding furniture support mechanism 72. The pivoting furniture support mechanism 70 comprises a base 74, a pivot 76, and a pivot plate 78. Applicant notes that one skilled in the art would realize that the base 74 alone can serve as a pivoting furniture support mechanism. Mounted to the pivot plate 78 of the pivoting support mechanism is the sliding furniture support mechanism. The sliding furniture support mechanism comprises a first surface 80 and a second surface 82 which move laterally in relationship to one another. In this embodiment, the second surface 82 comprises angle walls 84 to entrap the first surface and prevent it from falling away from the second. Optionally, this embodiment also includes a frictional slide control means 85. The friction slide control means increases or decreases the friction between the sliding surfaces controlling the rate or ease of slide. One skilled in the art would realize that there are a number of means to achieve this control. In this embodiment, friction is controlled by a screw knob that increases and decreases the distance between the first sliding surface and the second sliding surface. These furniture support assemblies allow bi-directional pivot and bi-directional sliding. Bi-directional sliding is sliding in lateral movement in opposite directions.

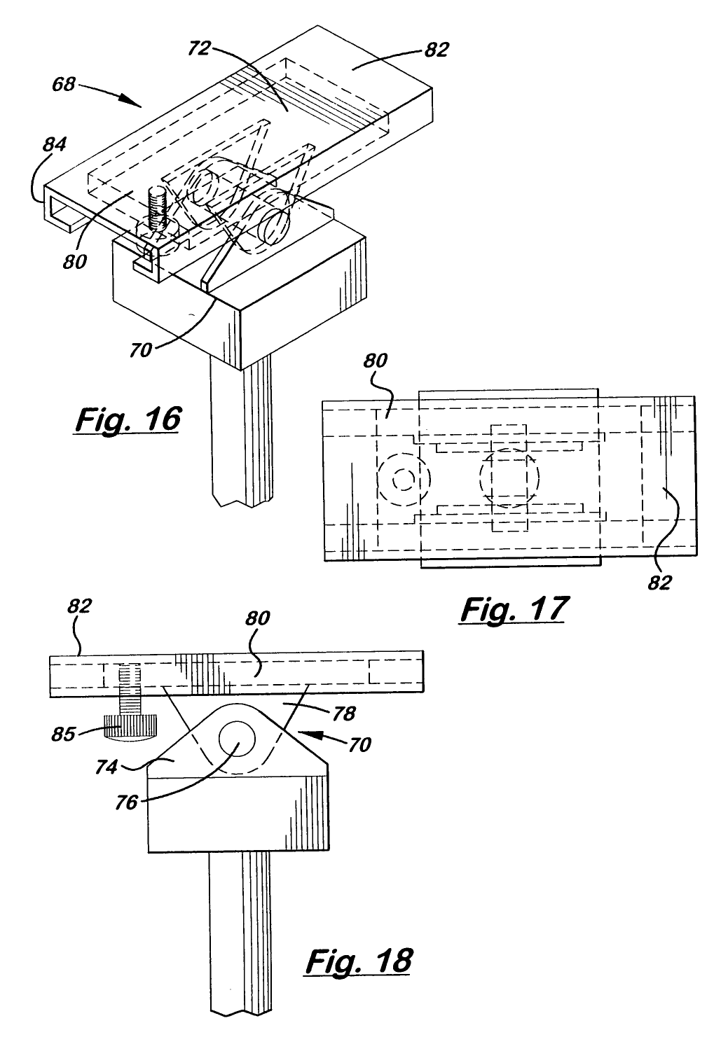

FIGS. 19-21 show another preferred embodiment of a furniture support assembly 86 comprising a pivoting furniture support mechanism 88 and a sliding furniture support mechanism 90. The pivoting furniture support mechanism comprises a base 92 and a pivot 94. A roller 96 is rotatably attached to the pivot 94 as part of the sliding furniture support mechanism. The roller 96 is the first surface of the slider. The second surface 98 is a track which encloses the roller. The roller is a sliding surface which offers less resistance and friction than a flat surface. A frictional slide control knob 100 controls both pivot and slide. The threaded knob draws the roller to the track increasing friction between the sliding surfaces. The knob also draws the slider mechanism to the base 92 of the pivot increasing the friction between the base and the track which pivots about the pivot. These furniture support assemblies allow bi-directional pivot and bi-directional slide.

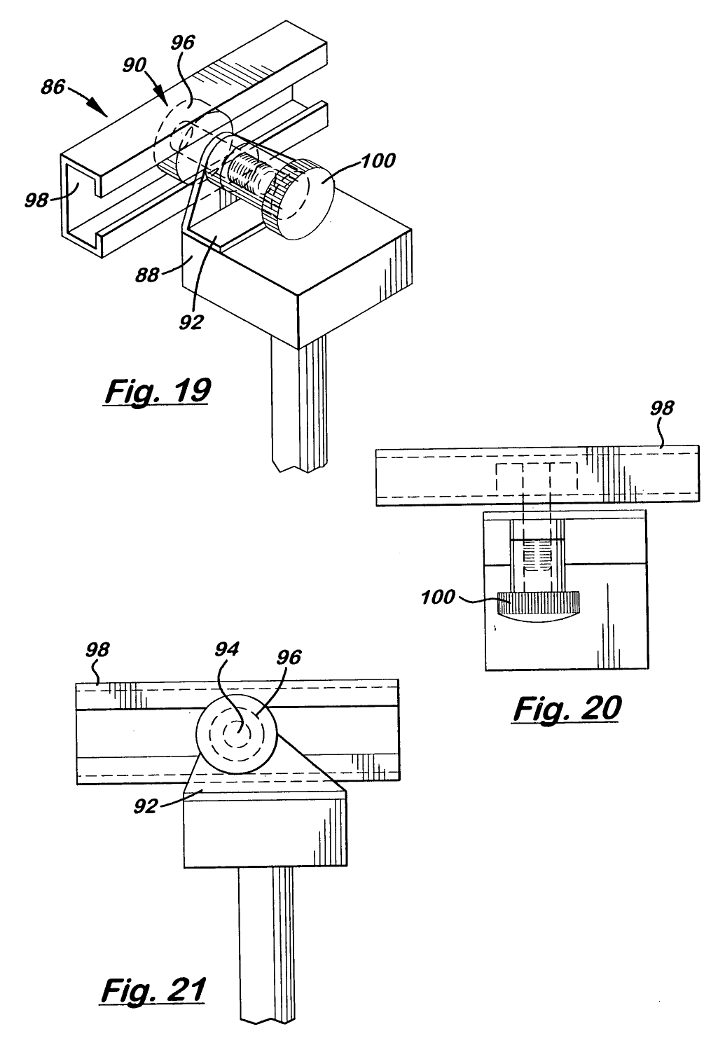

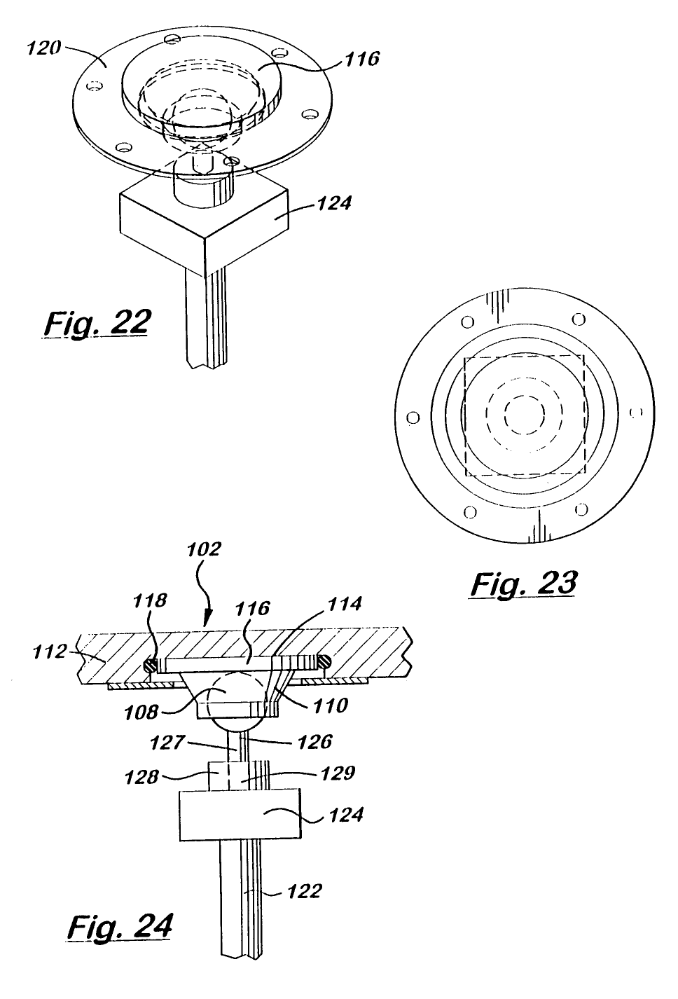

FIGS. 22-24 show a furniture support assembly 102 comprising a pivoting furniture support mechanism comprising a ball 108 which pivots within a socket or cone 110. A furniture component or furniture support mechanism 112 is adapted by machining a circular depression 114 into the underside of the furniture component or into a furniture support mechanism. The circular depression is larger in diameter than a disk slider providing for omni-directional sliding of a disk slider. The first surface of the slider, the disk, moves laterally along the second surface of the slider, the depressed surface 114 of the furniture component or furniture support mechanism omni-directionally. A deformable buffer 118 for example a rubber gasket, provides for cushioned movement of the disk within the depression. A flange 120 is used to conjoin the sliding surfaces of the depressed surface and the disk surface for omni-directional lateral movement in relation to each other without becoming separated. This furniture support assembly allows for omni-directional pivoting and omni-directional sliding of this furniture support assembly in relationship to a furniture component, another furniture support assembly, or a height adjustable telescoping column. This is because the second surface of the slider can be machined into a support assembly, a support assembly block, or directly on top of a flat surface of a height adjustable telescoping column. The entire ball-socket-disk assembly of FIG. 22 can be inverted and slidably received in a circular depression machined into the attachment block 124. Applicant notes, the furniture component need not be modified for the subject sliding furniture support mechanism. A circular track can be bolted to the bottom of the component. Further, the disk alone beneath, for example, a tabletop provides the slide required by the subject invention.

The pivoting support mechanism of FIG. 24 is attached to a telescoping column 122 by an attachment block 124. To emphasize the pivoting and sliding furniture support mechanisms and decrease clutter in the figures, attachment blocks are often depicted in this application as simple squares. Applicant notes that these blocks are not always necessary as means for attaching the pivoting and sliding mechanisms to the telescoping columns. The mechanisms, as shown previously, can be directly attached to the columns. Additionally, blocks need not be attached by a simple weld. For example, a block can have a socket to rotatably receive the upper section of a column. In the embodiment of the invention shown in FIG. 24, an attachment block 124 rotatably receives the pivoting support mechanism through a spindle 126. The spindle 126 has a first end 127 attached to the pivoting furniture support mechanism and a second end 129 attached to the telescoping column 122 a pocket 128 on the attachment block 124.

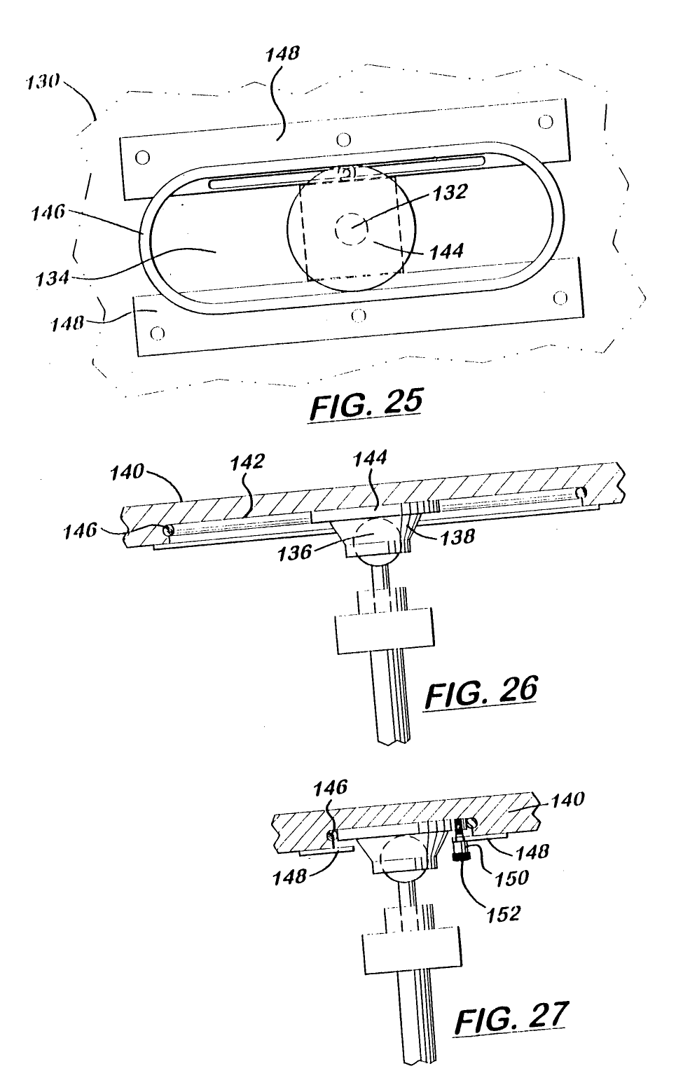

FIGS. 25-27 show a furniture support assembly 130 comprising a pivoting furniture support mechanism 132 and a sliding furniture support mechanism 134. The pivoting furniture support mechanism 132 comprises a ball 136 pivoting within a socket or cone 138. A furniture component or furniture support mechanism 140 is adapted by machining an oblong depression 142 into the underside of the furniture component or into a furniture support mechanism. The oblong depression at its narrowest width is a greater distance than the diameter of a disk slider providing for omni-directional sliding of a disk slider but favoring bi-directional sliding owing to the fact that the length of the depressed oblong surface comprises a much greater distance in length than the diameter of a disk slider. The oblong depression 142 slidably receives a disk 144 attached to the pivoting furniture support mechanism and forms the sliding furniture support mechanism. The first surface of the slider, the disk, moves laterally along the second surface of the slider, the depressed oblong surface of the furniture component or furniture support mechanism omni-directionally but is specially adapted for favoring bi-directional sliding at a much greater distance than its omni-directional capabilities. A deformable buffer 146 lines the wall of the depression to provide cushioned movement of the disk within the depression. Plates 148 along each side of the depression us used to conjoin the sliding surfaces of the depressed surface and the disk surface for omni-directional lateral movement in relation to each other without becoming separated. Applicant notes, the furniture component need not be modified for the subject sliding furniture support mechanism. A simple track can be bolted to the bottom o the component. Further, the disk alone beneath, for example, a tabletop provides the slide required by the subject invention. This embodiment further comprises a frictional slide control 150. The frictional slide control is a knob 152 which moves the disk 144 toward or away from the depressed surface to increase or decrease the friction between the disk surface and the depressed surface to control the slide. It is noted that the pivoting and sliding furniture support mechanisms shown engage the furniture component. These mechanisms can likewise be configured to engage the column or another support assembly. The furniture support assembly allows omni-directional pivot and omni-directional slide, but favors bi-directional sliding of this furniture support assembly in relationship to a furniture component, another furniture support assembly, or a height adjustable telescoping column. This is because the second surface of the slider can be machined into a support assembly or a support assembly block positioned above a height adjustable telescoping column.

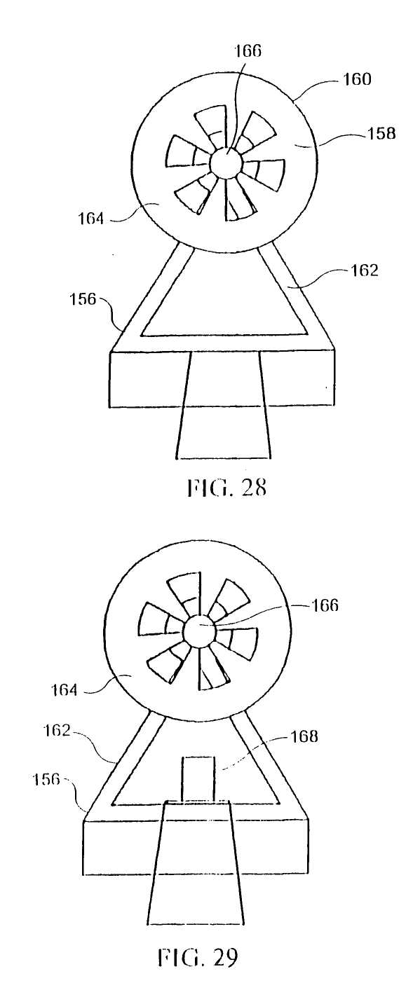

FIGS. 28 and 29 show another preferred embodiment of a furniture support assembly 156 comprising a pivoting furniture support mechanism 158 and a sliding furniture support mechanism 160. The mechanism comprises a base 162 with a roller 164. A furniture component can pivot about the apex of the roller. Alternatively, the axle 166 of the roller can act as a pivoting surface. The first sliding surface of the roller 164 contacting the underside of the second sliding surface of the furniture component allows the furniture component to move laterally above the columns. This base and roller configuration placed in pairs above a column provide further stability to the subject pedestal. FIG. 29 illustrates that this embodiment of a furniture support assembly allows access to an actuation button 168 on a gas spring. The furniture support assembly allows bi-directional pivot and bi-directional slide.

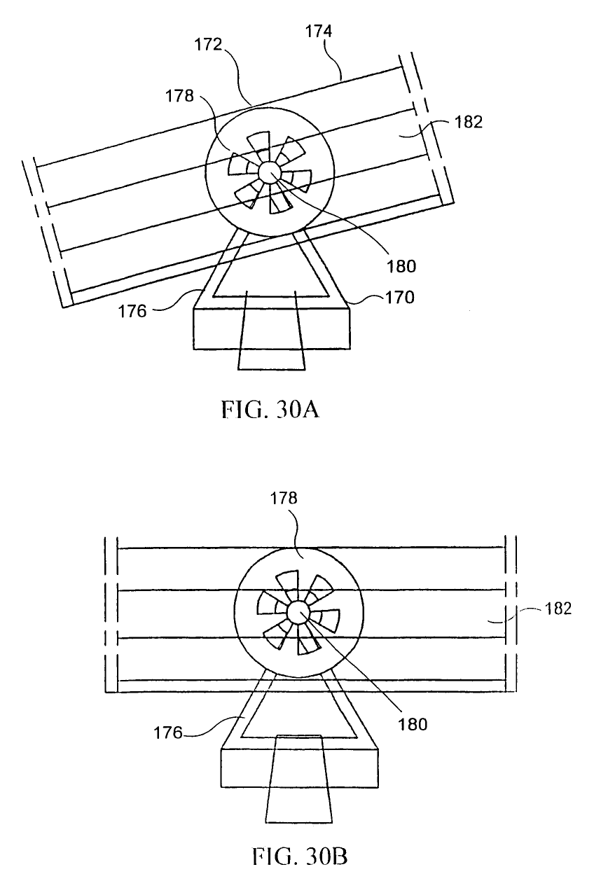

FIGS. 30A and 30B show another preferred embodiment of a furniture support assembly 170 comprising a pivoting furniture support mechanism 172 and a sliding furniture support mechanism 174. The pivoting furniture support mechanism 172 has a base 176 and a roller 178 rotating about an axis 180. The roller 178 provides the first surface of the sliding furniture support mechanism. The sliding furniture support mechanism 174 further includes a track 182 as its second surface which captures the roller 178. The first surface of the roller moves laterally along the second surface of the track. The furniture support assembly allows bi-directional pivot and bi-directional slide.

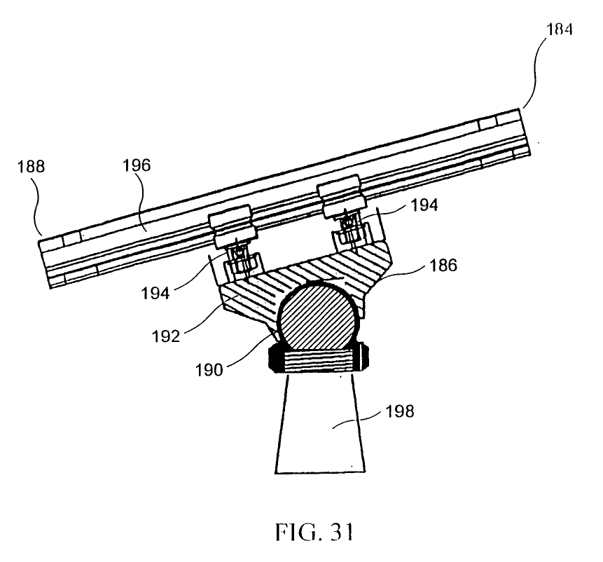

FIG. 31 shows another preferred embodiment of a furniture support assembly 184 comprising a pivoting furniture support mechanism 186 and a sliding furniture support mechanism 188. The pivoting furniture support mechanism has a ball 190 and socket 192. Rollers 194 are rotatably mounted to the surface of the socket to provide the first surface of the sliding furniture support mechanism. The rollers 194 are captured within a track 196 which provides the second surface of the slider. In this embodiment, the pivoting furniture support mechanism is threadably attached to a telescoping column 198 and the track 196 of the slider engages the furniture component or another furniture support assembly. This furniture support assembly allows bi-directions pivot and bi-directional slide.

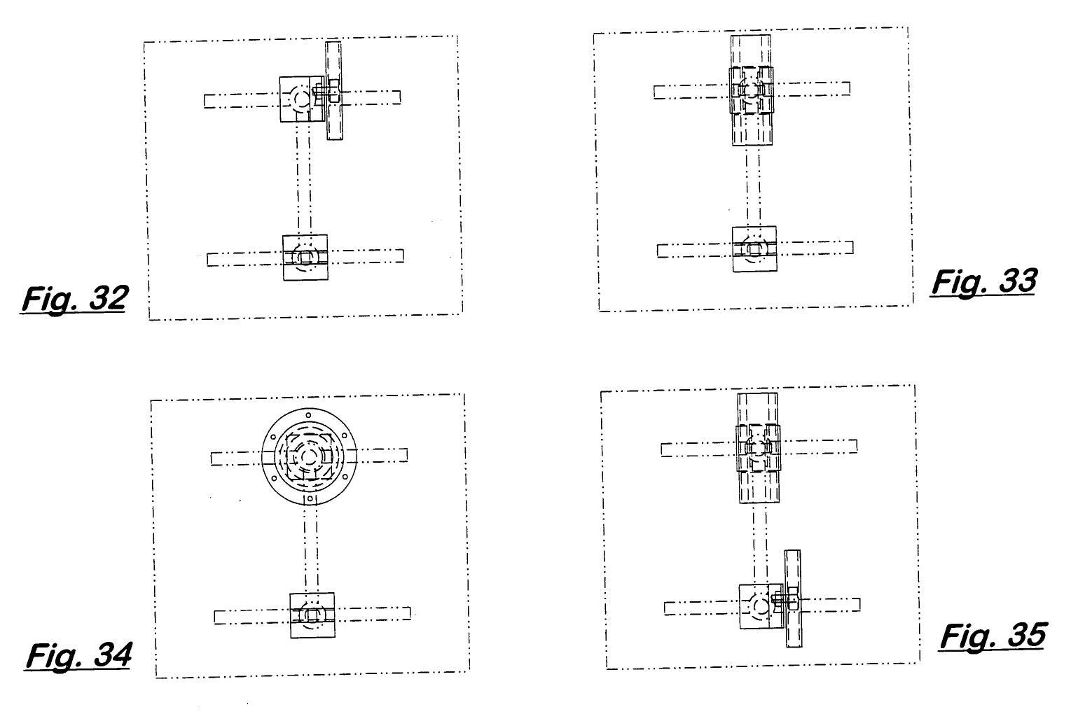

FIGS. 32-40 show preferred embodiments of two-column height adjustable pedestals of the subject invention. The furniture support mechanisms of these pedestals include furniture support assemblies comprising pivoting and/or sliding furniture support mechanisms shown and described previously. For example, the pedestal shown in FIG. 32 has the pivoting furniture support mechanism shown in FIG. 10 and the furniture pivoting and sliding support assembly shown in FIG. 19. FIG. 33 shows a pedestal including the pivoting and sliding furniture support assembly of FIG. 16 and the pivoting furniture support mechanism of FIG. 10. FIG. 34 shows a pedestal including the pivoting and sliding furniture support assembly shown in FIG. 22 and the pivoting furniture support mechanism shown in FIG. 10.

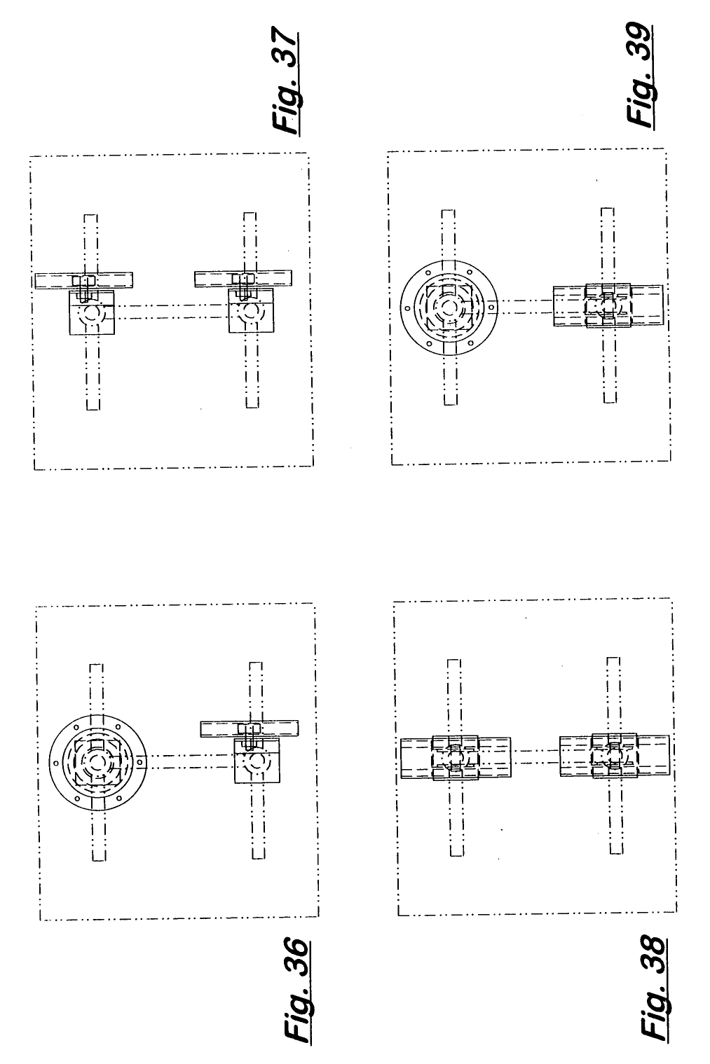

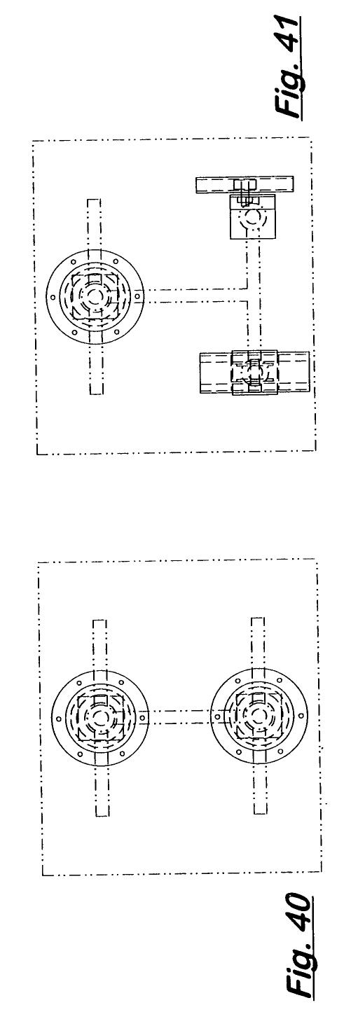

Each pedestal has at least two columns, at least two pivots, and at least one slide. Thus, the columns on all pedestals pivotally and slidably engage the furniture component. Whether the furniture component tilts and/or slides above the columns depends upon the configuration of the furniture support mechanism. For example, FIGS. 32-34 show pedestals on which the furniture component tilts above the columns, while FIG. 35 shows a pedestal on which the furniture component slides bi-directionally above the columns. The pedestal shown in FIG. 36 has a tilting furniture component. The pedestals shown in FIGS. 37 and 38 have bi-directionally sliding furniture components. FIGS. 39 and 40 show pedestals which tilt.

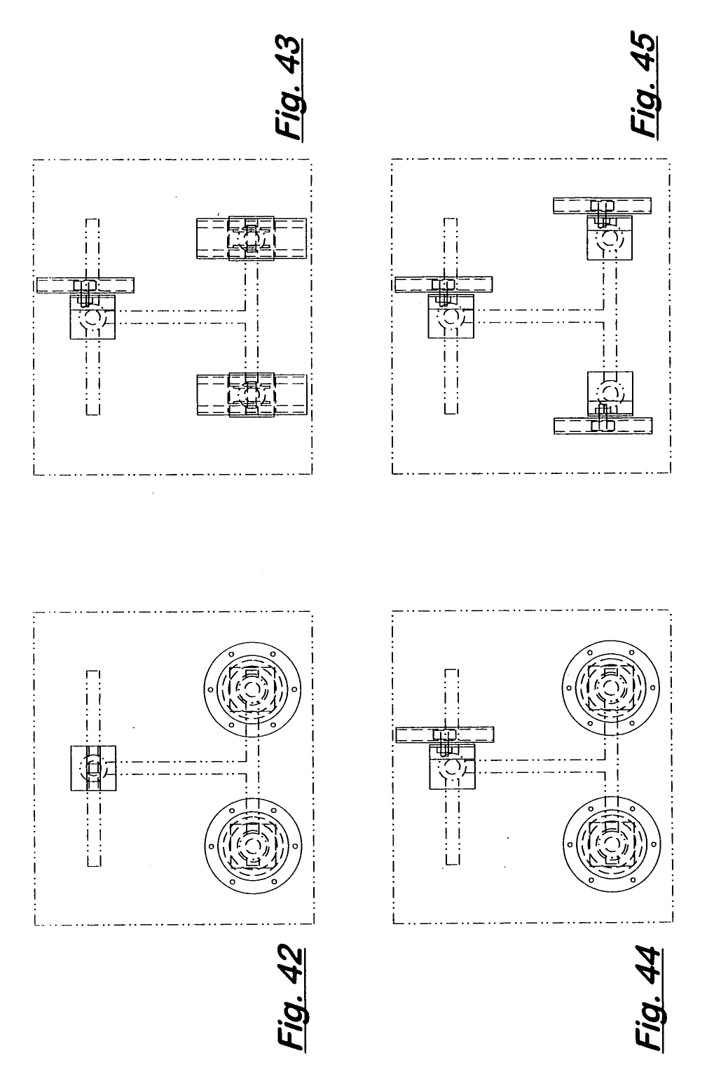

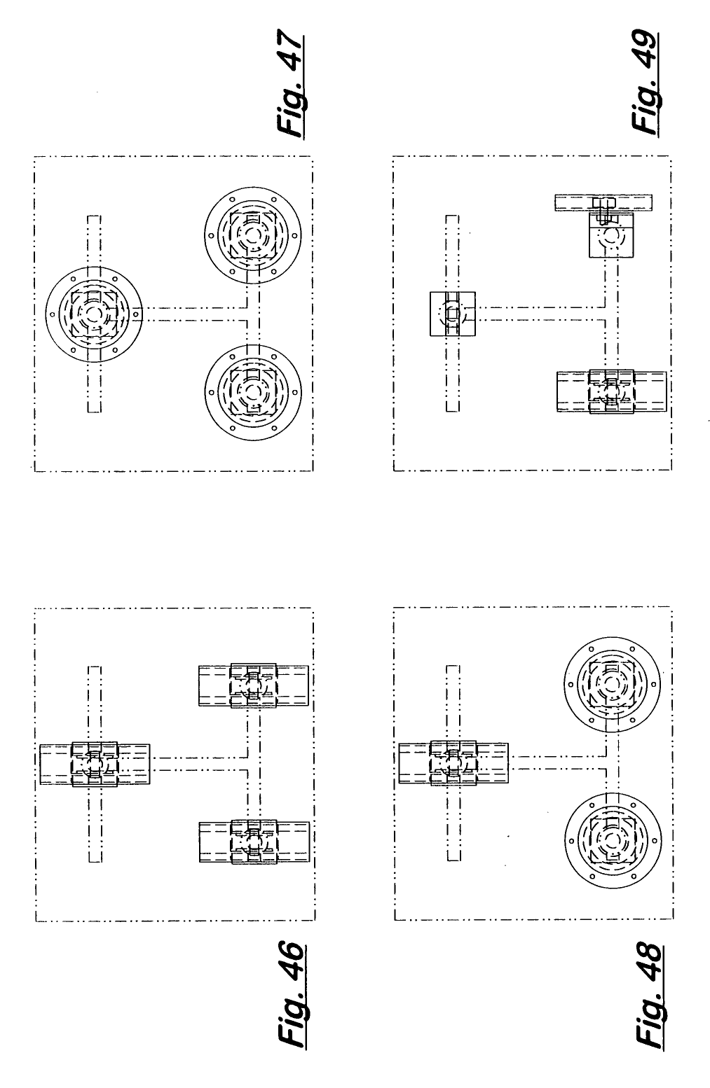

FIGS. 41-49 show preferred embodiments of three-column height adjustable pedestals of the subject invention. The furniture components of FIGS. 41, 44, 48 and 49 tilt. The furniture components of the pedestals in FIGS. 43, 45, and 46 slide bi-directionally above the columns.

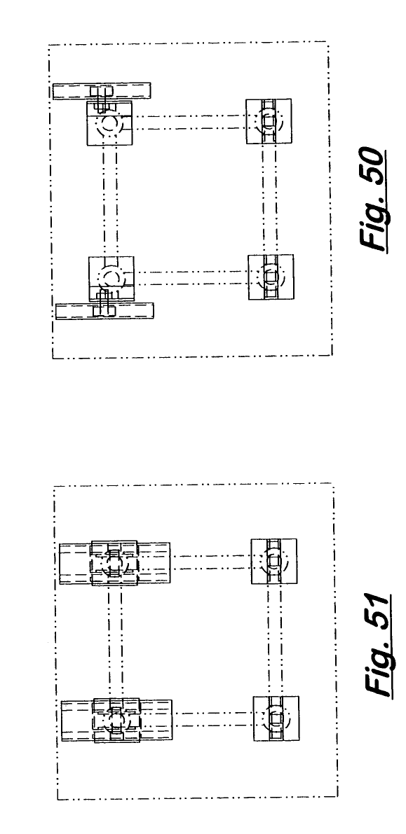

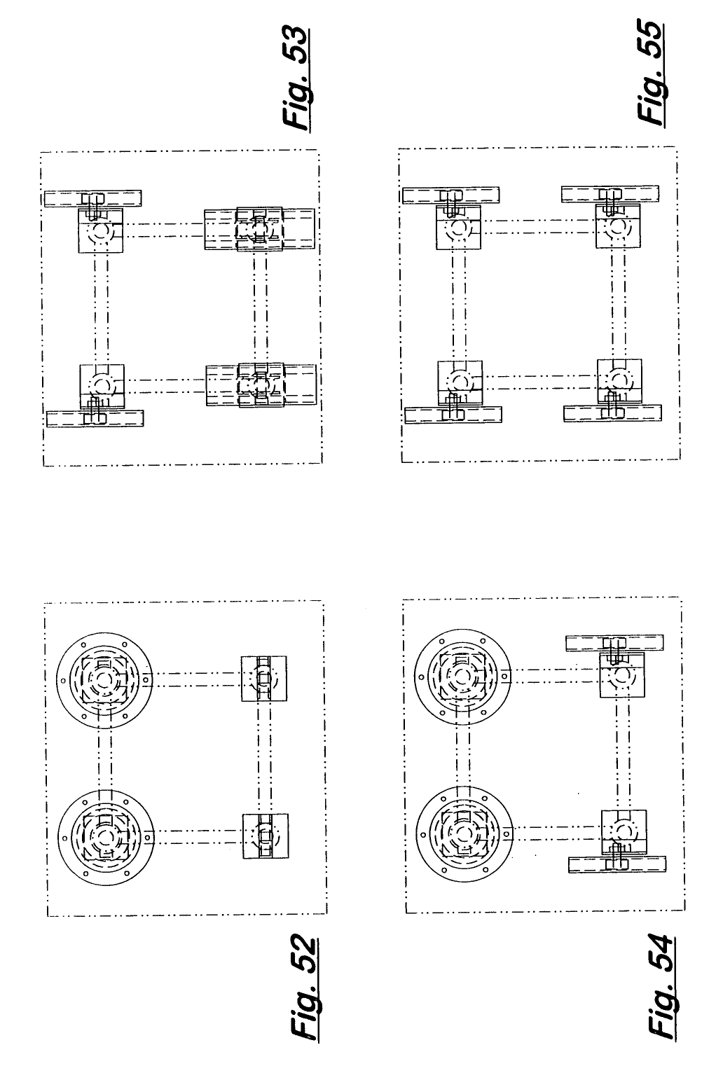

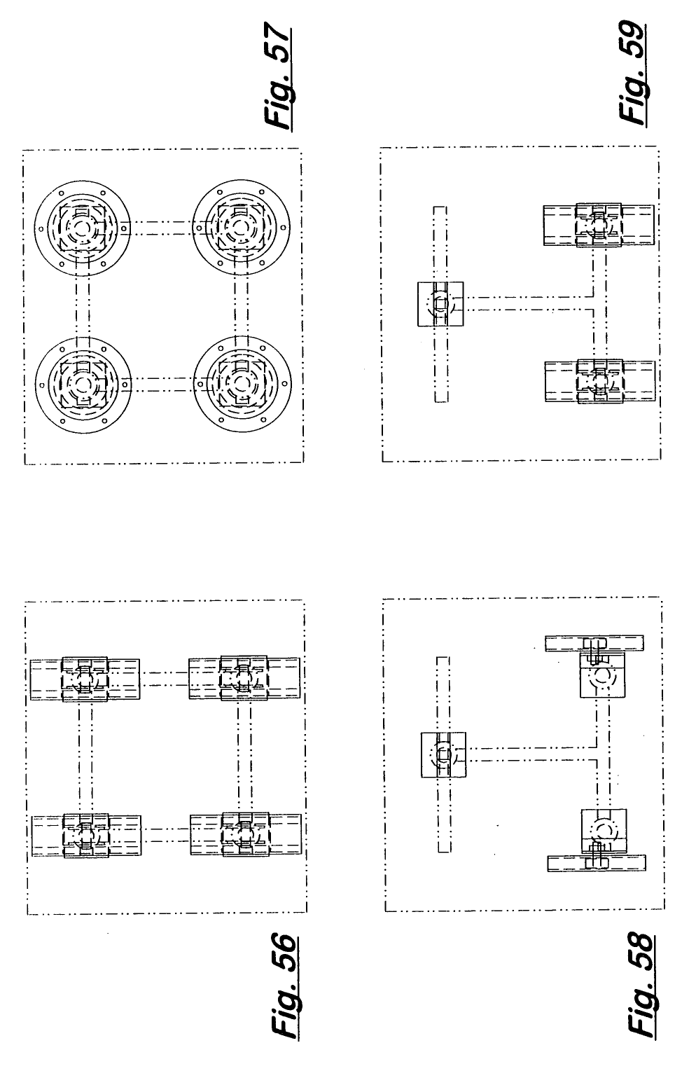

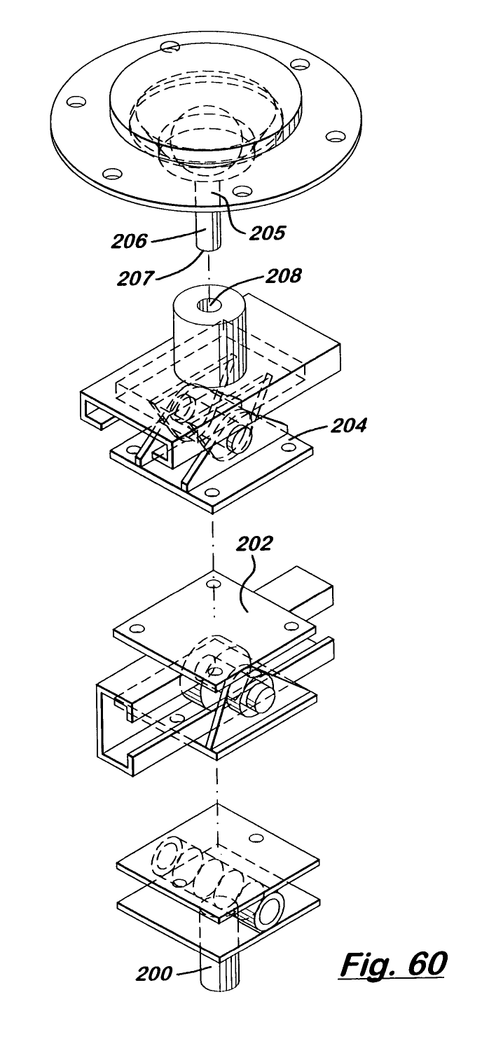

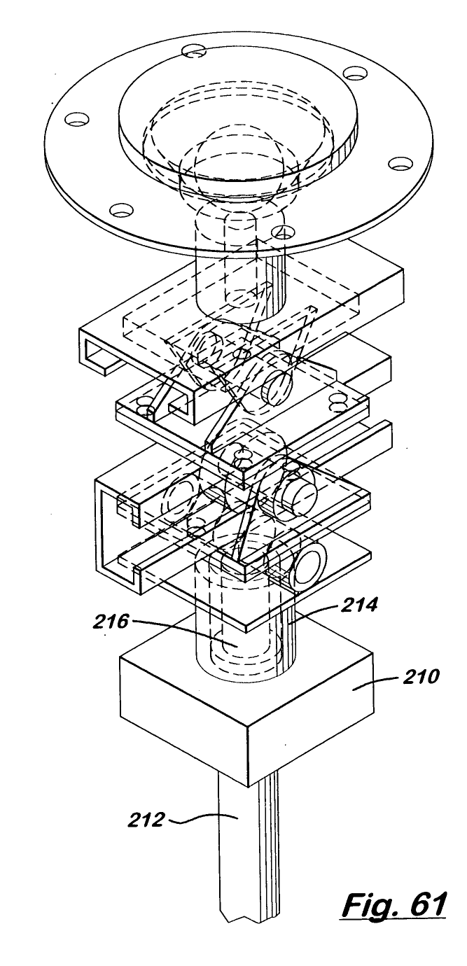

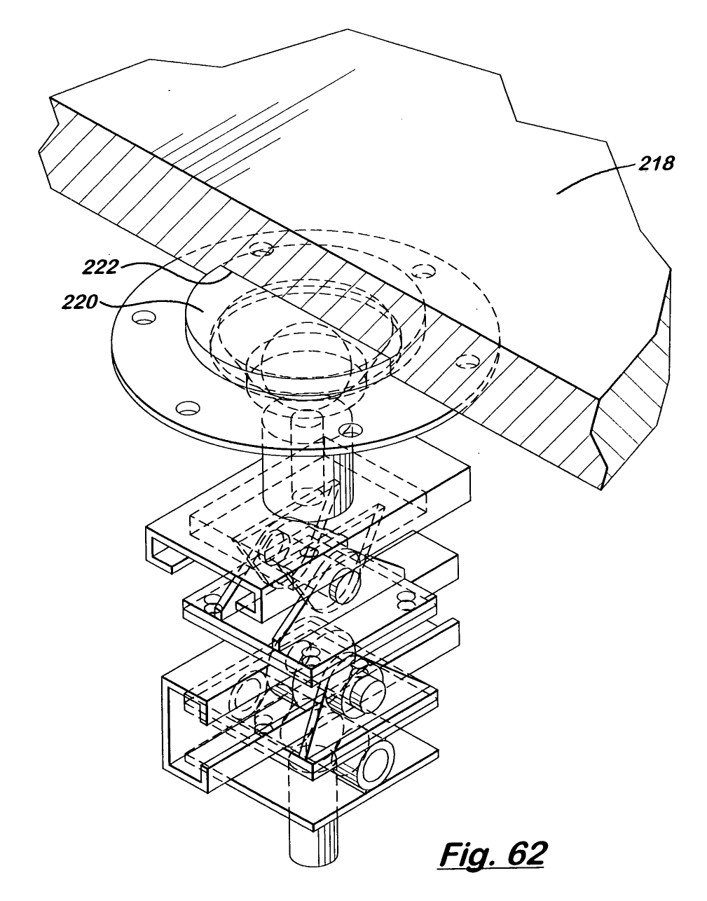

FIGS. 50-59 show preferred embodiments of four-column height adjustable pedestals of the subject invention. The furniture components of the pedestals shown in FIGS. 50-51, 54, 58, and 59 tilt above the columns. The furniture components of the pedestals shown in FIGS. 53, 55 and 56 slide bi-directionally.

FIG. 60 shows a preferred embodiment of stacked furniture support mechanisms. Three pivoting and sliding mechanisms are stacked atop a pivoting mechanism. The pivoting furniture support mechanism shown in FIG. 10 is connected to a telescoping column 200. The pivoting and sliding furniture support mechanisms shown in FIG. 19 is stacked upon the pivot, the pivoting and sliding mechanism shown in FIG. 16 is stacked upon that and finally the pivoting and sliding mechanism shown in FIG. 22 is stacked upon that mechanism. Note, each mechanism has plates and connectors to attach one mechanism to another. For example, a base plate 202 of one pivoting and sliding furniture support mechanism is attached to a top plate 204 of another pivoting and sliding mechanism. The upper most pivoting and sliding mechanism is mounted on a spindle 206. A first end 205 of the spindle is attached to the furniture support mechanism. A second end 207 of the spindle rotatably engages receiving sleeve 208 on the adjacent pivoting and sliding mechanism. One skilled in the art will appreciate that there are many ways to attach one mechanism to another. The uppermost mechanism allows omni-directional pivot and the sliding mechanisms provide bi-directional slide.

FIG. 61 shows the same stacked embodiment of pivoting and sliding furniture support mechanisms shown in FIG. 60 rotatably attached to a telescoping column. An attachment block 210 is attached to the telescoping column 212. A receiving sleeve 214 is attached to the block to rotatably receive a spindle 216 mounted to the bottom of the first pivoting mechanism. Applicant notes, the attachment block 210 could be bored to receive the spindle 216.

FIG. 62 shows the same stacked embodiment of pivoting and sliding furniture support mechanisms shown in FIG. 60 engaging a furniture component 218. In this embodiment, the furniture component 218 is adapted to receive the first sliding surface 220 of the sliding mechanism. A circular depression 222 with a larger diameter than 220 cut in the component forms, the second sliding surface. Applicant notes that the furniture component need not be adapted and that the sliding mechanism can comprise a second track piece to provide the second sliding surface. The applicant further notes the entire stacked unit could be turned on end so that the furniture support mechanisms pivotally and slidably engage the telescoping column.

The illustrated embodiment of stacked furniture support mechanisms provided omni-directional pivot and bi-directional slide. It should be apparent to one skilled in the art that by varying the orientation of stacked mechanisms one can achieve omni-directional pivoting and omni-directional sliding of the furniture component in relationship to one or more telescoping columns. For example, stacking two bi-directional sliding mechanisms at 90 degrees will allow the furniture component to slide back and forth and side to side. Likewise, stacking bi-directional pivots at 90 degrees will allow the furniture component to tilt back and forth and side to side. It is the pivotal and sliding engagement of the telescoping columns with the component that allows the telescoping members of the columns to remain aligned and functional within the pedestal.

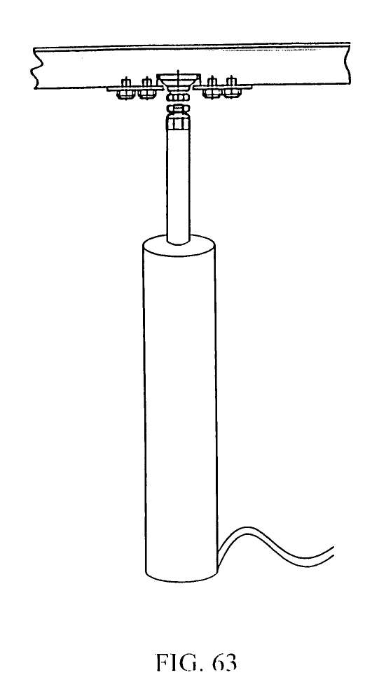

FIG. 63 shows another preferred embodiment of a pivoting and sliding furniture support mechanism of the pedestals of the subject invention. It is important to note that the subject pedestals can contain any type of telescoping columns, including, but not limited to, as in this case, electro-mechanical columns.

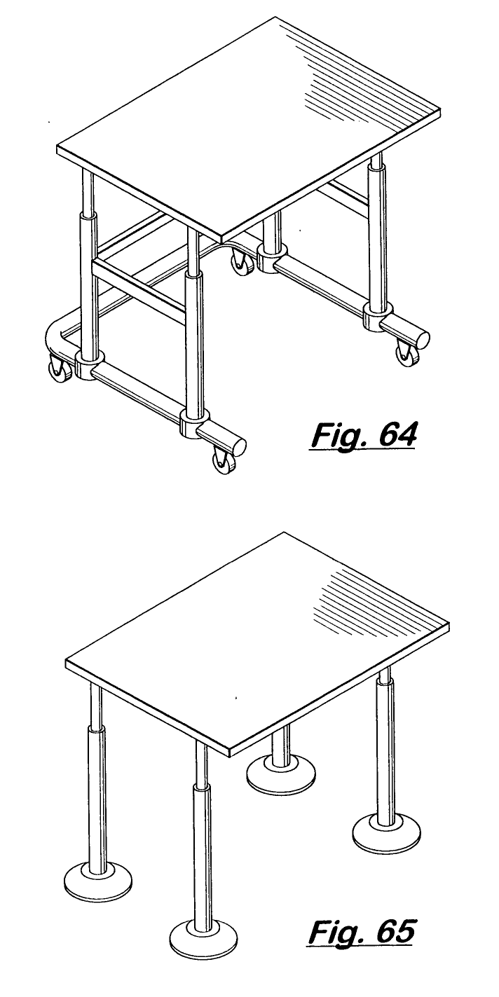

FIGS. 64 and 65 show preferred embodiments of the pedestals of the subject invention. Each embodiment has four telescoping columns each supported by a base section. In FIG. 64, the base sections are connected. The base sections on the pedestal of FIG. 65 are not connected.

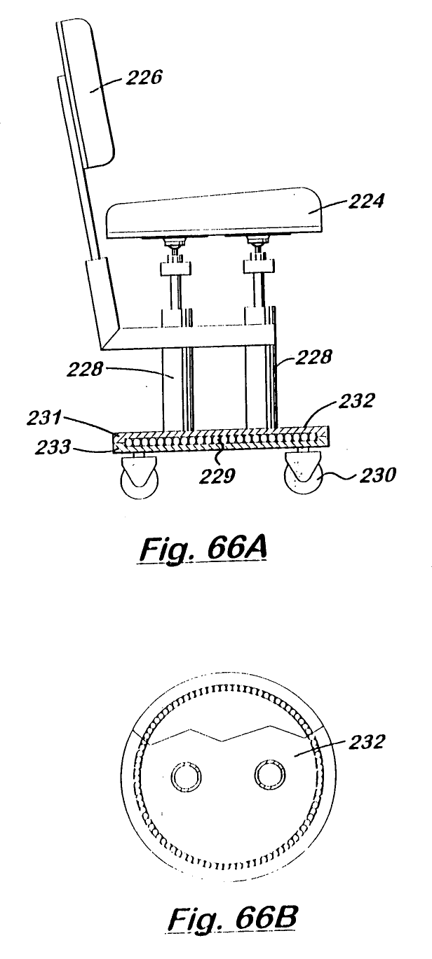

FIGS. 66A and 66B show another preferred embodiment of the pedestal of the subject invention. In this embodiment, the pedestal has two telescoping columns and the furniture component 224 is a chair seat. A back support 226 is fixedly attached to the lower sections 228 of the telescoping columns. The pedestal sits on casters 230 and the base comprises a swivel 232. Swivels are well known in the art. Briefly, a swivel includes an upper plate 231, a lower plate 233 and a low friction bearing assembly 229. The lower friction bearing assembly separates the upper and lower plates and allows the unit to swivel. In a particularly preferred embodiment, the swivel has a friction swivel control means to selectively control the ease of swivel in the swivel mechanism by affecting the friction. The swivel is shown in cross-section in FIG. 66B.

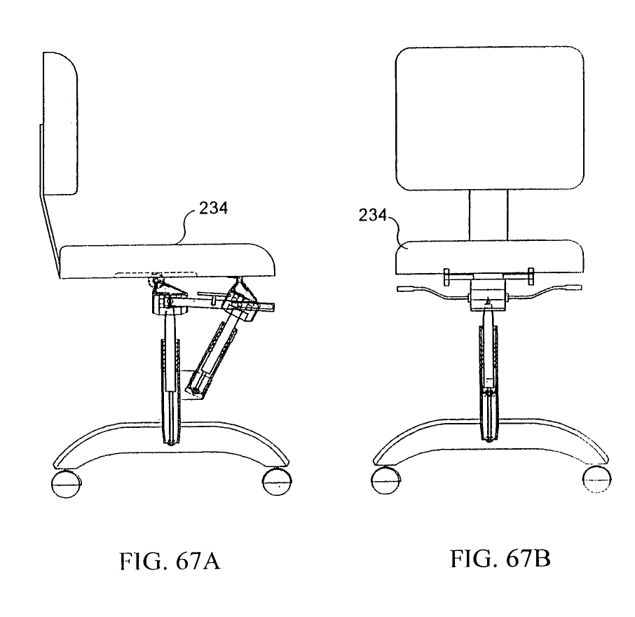

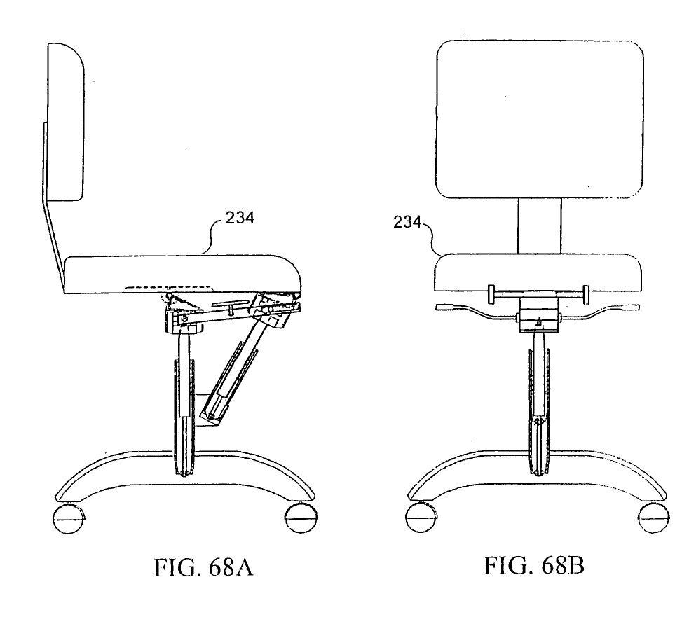

FIGS. 67A and 67B and 68A and 68B show other preferred embodiments of the pedestal of the subject invention. The subject pedestals comprise two telescoping columns. In each embodiment, the furniture component 234 is a chair seat that has been adapted to slidably engage the furniture support mechanism. Additionally, in each embodiment, the lower section of the second column is pivotally connected to the lower section of the first column.

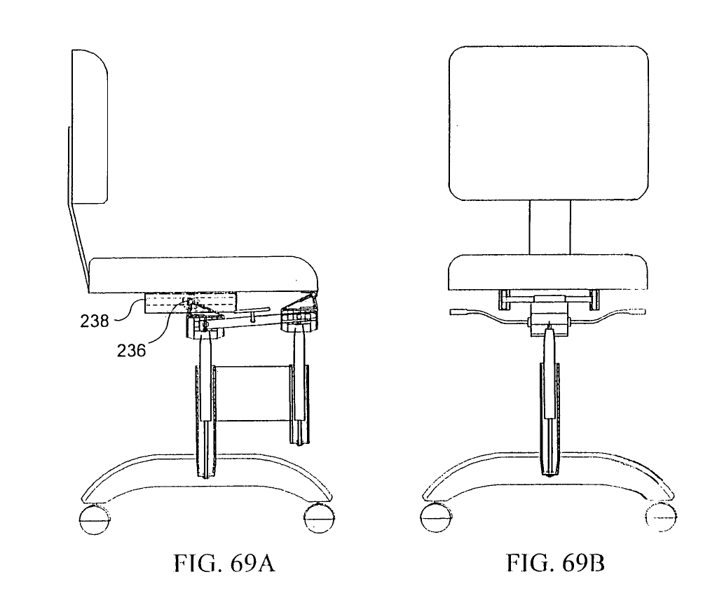

FIGS. 69A and 69B show another preferred embodiment of the pedestal of the subject invention. In the two-column pedestal of this embodiment, the lower section of the second column is fixedly attached to the lower section of the first column. Applicant notes, the sliding furniture support mechanism attached to the furniture component has a first sliding surface that is a pin 236 and a second sliding surface that is a slot 238.

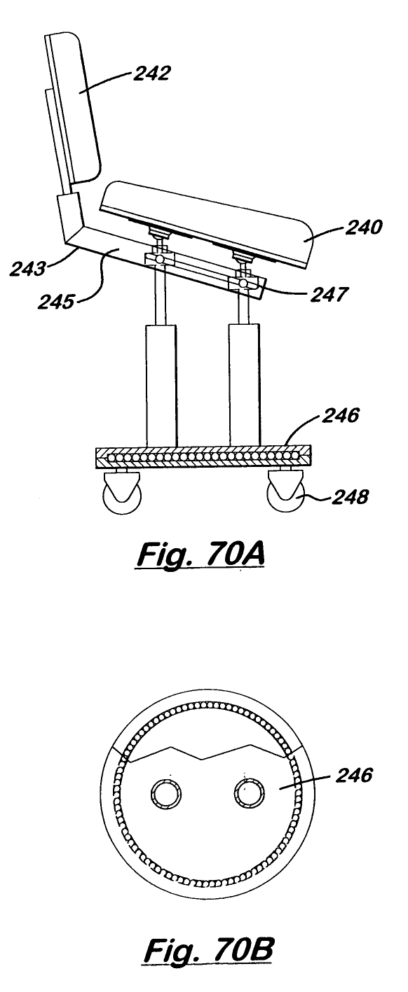

FIGS. 70A and 70B show another preferred embodiment of the pedestal of the subject invention. This two column pedestal has a chair seat for a furniture component 240. A back support 242 slidably engages the furniture support mechanism 244 through slidable engagement means 243. In this embodiment, the slidable engagement means include a track 245 with a slot to receive threaded pins 247 which slide along the slot. One skilled in the art is well aware of other means by which the back support can slidably engage the columns so that the support can move relative to the furniture component. The pedestal base has a swivel 246 which is shown in cross-section in FIG. 70B and sits on casters 248.

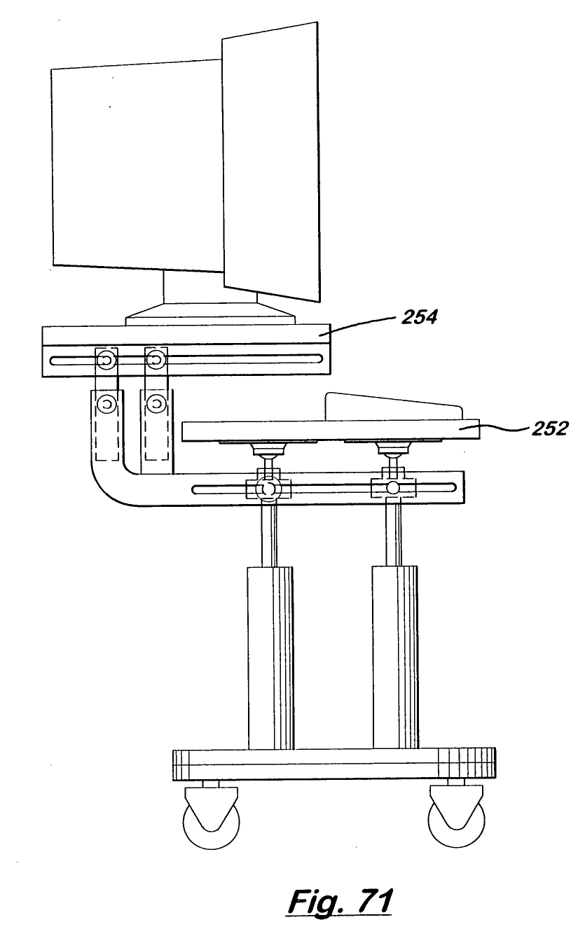

FIG. 71 shows another preferred embodiment of a four-column pedestal of the subject invention. The pedestal comprises a second furniture component which is slidably connected to the furniture support mechanism of the pedestal. The first furniture component 252 and the second furniture component 254 are table tops and are depicted as being used as a keyboard and monitor stand. The first furniture component 252 can pivot and slide above the telescoping columns. The second furniture component 254 is supported by four telescoping columns. The second furniture component can pivot and slide in relationship to the first allowing adjustment to the optimum eye to monitor distance.

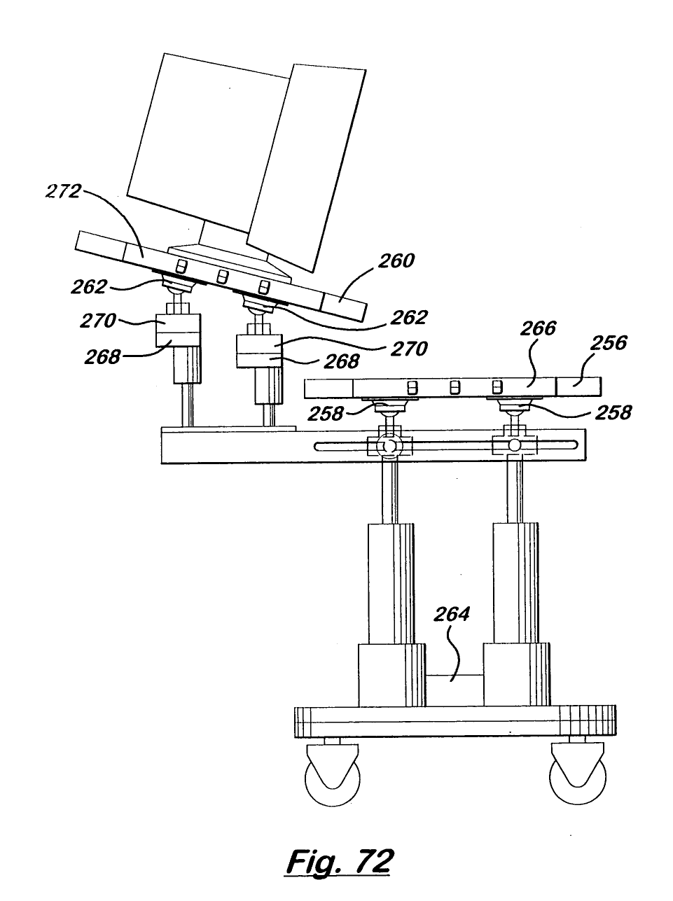

FIG. 72 shows another preferred embodiment of a pedestal of the subject invention. The subject pedestal has electro-mechanical telescoping columns. This embodiment also has a second furniture support mechanism that is a table top. The first furniture component 256 is supported by four telescoping columns. Disposed above each column is a pivoting and sliding furniture support mechanism 258. The columns thus pivotally and slidably engage the first furniture component which can slide and pivot above them permitting the columns to remain aligned and functional. A second furniture component 260 slides relative to the first 256. In this embodiment, the second furniture component 260 is supported by four telescoping electro-mechanical columns. Disposed above each column is a pivoting and sliding furniture support mechanism 262. Thus, the telescoping members of the columns supporting the second furniture component are prevented from binding because the component can tilt and slide above them.

All columns in this exemplified embodiment are electro-mechanical. The columns supporting the first furniture component 256 are driven by a single motor 264. A switch box 266 is conveniently placed along the side of the furniture component, which in this case is a table top, to control the extension and retraction of the columns. In this embodiment, for example, one switch can be used to control the columns closest to the user while another can be used to control the columns furthest from the user. This allows the table top to be tilted toward and away from the user. A third switch can be used to simultaneously control all four columns allowing the user to raise and lower the table top while it is in a tilted position. The columns supporting the second furniture support mechanism 260, also a table top, are also electro-mechanical and illustrate that the larger section of the telescoping column need not be the section connected to the base. Each column is driven by its own motor 268 supported upon an attachment block 270. A switch box 272 is again conveniently located along the table top and is wired to control the front set, the back set or all four columns simultaneously. Applicant notes the present system could likewise be controlled by a wireless remote.

It should be understood that the examples and embodiments described herein are for illustrative purposes only and that various modifications or changes in light thereof will be suggested to persons skilled in the art and are to be included within the spirit and purview of this application and the scope of the appended claims.

1. A height adjustable pedestal comprising:
a floor contacting base comprising at least first and second base sections;
a first height adjustable telescoping column disposed above the first base section and supported by the first base section; wherein the first height adjustable telescoping column is comprised of a lower section attached to the first base section and supported by the first base section, and an upper section that can move upwardly and downwardly in relationship to the lower section; wherein the first height adjustable telescoping column can be adjusted in height in relationship to the first base section;
at least a second height adjustable telescoping column disposed above the base and supported by the base; wherein the second height adjustable telescoping column is comprised of a lower section and an upper section, wherein the upper section can move upwardly and downwardly in relationship to the lower section; wherein the second height adjustable telescoping column can be adjusted in height in relationship to the base;
a first furniture support mechanism disposed above all of the height adjustable telescoping columns and comprising first, second and third furniture support assemblies;
wherein the first furniture support assembly comprises at least a first pivoting furniture support mechanism disposed above a first height adjustable telescoping column and below a furniture component; wherein the pivoting furniture support mechanism includes a pivot that provides for a pivotal engagement between the first height adjustable telescoping column and a first furniture component;
wherein the second furniture support assembly comprises at least a first pivoting furniture support mechanism disposed above at least a second height adjustable telescoping column and below a first furniture component; wherein the second pivoting furniture support mechanism includes a pivot that provides for a pivotal engagement between the at least second height adjustable telescoping column and a first furniture component;
wherein the third furniture support assembly includes at least a first sliding furniture support mechanism disposed above at least a first height adjustable telescoping column and below a first furniture component; wherein the furniture support sliding mechanism is comprised of at least a first surface that moves laterally in relationship to at least a second surface; and wherein the first furniture support sliding mechanism provides for lateral displacement between at least a first height adjustable telescoping column and a first furniture component;
wherein any of the pivoting furniture support mechanisms of the first and second furniture support assemblies of any of the furniture support assemblies can be disposed in a stacked relationship with each other, wherein a first pivoting furniture support mechanism disposed in a vertical plane above or below at least a second pivoting furniture support mechanism will allow for multi-directional pivoting of a first furniture component in relationship to at least a first height adjustable column;
and wherein at least first and second sliding furniture support mechanisms can be disposed in a stacked, slidable relationship with each other, wherein a first sliding furniture support mechanism disposed in a vertical plane above or below at last a second sliding furniture support mechanism will allow for multi-directional sliding of a first furniture component in relationship to at least a first height adjustable column;
and wherein any of the first, second or third furniture support assemblies can be disposed in any combination of a stacked relationship with each other, wherein at least a first furniture support assembly is disposed in a vertical plane above or below at least a second furniture support assembly;
a first furniture component disposed above the first furniture support mechanism and pivotally supported by the first furniture support mechanism;
wherein at least a first height adjustable telescoping column can be moved upwardly and downwardly, independently of any other height adjustable telescoping columns; causing the first furniture component to tilt;
and wherein all of the height adjustable telescoping columns can be moved upwardly and downwardly simultaneously, wherein the first furniture component will be adjusted in height in relationship to the floor.

2. The height adjustable pedestal of claim 1, wherein at least a first height adjustable telescoping column is not connected to the base.

3. The height adjustable pedestal of claim 1, wherein the second height adjustable column is disposed above the second base section and supported by the second base section; wherein the second height adjustable telescoping column is comprised of a lower section connected to the second base section and supported by the second base section, and an upper section that can move upwardly and downwardly in relationship to the lower section; wherein the first height adjustable telescoping column can be adjusted in height in relationship the second base section.

4. The height adjustable pedestal of claim 1, wherein the lower section of at least a first height adjustable telescoping column includes a pivot mechanism and is pivotally connected to a second height adjustable column.

5. The height adjustable pedestal of claim 1, wherein at least a first pivoting furniture support mechanism is disposed above at least a first height adjustable telescoping column and pivots in relationship to a first height adjustable telescoping column.

6. The height adjustable pedestal of claim 1, wherein at least a first pivoting furniture support mechanism is disposed above at least a first height adjustable telescoping column and pivots in relationship to the first furniture component.

7. The height adjustable pedestal of claim 1, wherein at least a first pivoting furniture support mechanism is disposed above at least a first height adjustable telescoping column and pivots bi-directionally in relationship to at least a first height adjustable telescoping column.

8. The height adjustable pedestal of claim 1, wherein at least a first pivoting furniture support mechanism is disposed above at least a first height adjustable telescoping column and comprises a ball and socket; wherein the first pivoting furniture support mechanism pivots omni-directionally in relationship to at least a first height adjustable telescoping column.

9. The height adjustable pedestal of claim 9, wherein the ball rotates in relationship to the socket.

10. The height adjustable pedestal of claim 1, wherein at least a first pivoting furniture support mechanism disposed above at least a first height adjustable telescoping column is pivotally connected to at least a first height adjustable telescoping column.

11. The height adjustable pedestal of claim 1, wherein at least the first furniture support assembly disposed above the first height adjustable telescoping column is pivotally connected to the furniture component.

12. The height adjustable pedestal of claim 1, wherein the first furniture support mechanism disposed above at least a first height adjustable telescoping column is pivotally connected to at least a first furniture support assembly disposed above a first height adjustable column.

13. The height adjustable pedestal of claim 1, wherein the third furniture support assembly includes a frictional slide control means for controlling the ease of slide in at least a first sliding furniture support mechanism.

14. The height adjustable pedestal of claim 1, wherein at least a first sliding furniture support mechanism disposed above at least a first height adjustable telescoping column moves laterally in relationship to a first height adjustable telescoping column.

15. The height adjustable pedestal of claim 1, wherein at least a first sliding furniture support mechanism disposed above at least a first height adjustable telescoping column moves laterally in relationship to the first furniture component.

16. The height adjustable pedestal of claim 1, wherein at least a first furniture support assembly disposed above at least a first height adjustable telescoping column moves in a laterally bi-directional relationship to at least a first height adjustable telescoping column;

17. The height adjustable pedestal of claim 1, wherein at least a first furniture support assembly disposed above at least a first height adjustable telescoping column moves in a laterally omni-directional relationship to at least a first height adjustable telescoping column;

18. The height adjustable pedestal of claim 1, wherein at least a first furniture support assembly disposed above at least a first height adjustable telescoping column is disposed above and is slidably connected to at least a first height adjustable telescoping column.

19. The height adjustable pedestal of claim 1, wherein at least a first furniture support assembly disposed above at least a first height adjustable telescoping column is slidably connected to the first furniture component.

20. The height adjustable pedestal of claim 1, wherein at least the third furniture support assembly disposed above at least a first height adjustable telescoping column is connected to at least a second furniture support assembly disposed above a first height adjustable telescoping column.

21. The height adjustable pedestal of claim 1, wherein at least a first height adjustable telescoping column is adapted for a laterally movable attachment of the first furniture support mechanism.

22. The height adjustable pedestal of claim 1, wherein at least a first furniture support assembly is adapted for a laterally movable attachment to at least a second furniture support assembly.

23. The height adjustable pedestal of claim 1, wherein a stacked relationship of at least the first and the second furniture support assemblies when positioned in a ninety degree cross relationship to each other above a first height adjustable telescoping column will allow for omni-directional pivoting of the first furniture support mechanism in relationship to the first furniture component and at least a first height adjustable telescoping column.

24. The height adjustable pedestal of claim 1, wherein a stacked relationship of at least two of the third furniture support assemblies when positioned in a ninety degree cross relationship to each other above a first height adjustable telescoping column will allow for omni-directional sliding of the first furniture support mechanism in relationship to the first furniture component and at least a first height adjustable telescoping column.

25. The height adjustable pedestal of claim 24, wherein the stacked relationship of at least one of the first and one of the second furniture support assemblies when additionally stacked with the stacked relationship of the at least two third furniture support assemblies will allow for omni-directional pivoting and omni-directional sliding of the first furniture support mechanism in relationship to the first furniture component and at least a first height adjustable telescoping column.

26. The height adjustable pedestal of claim 1, wherein the first furniture component is adapted for a laterally movable attachment of the first furniture support mechanism.

27. The height adjustable pedestal of claim 1, wherein the first furniture support mechanism includes at least a first spindle comprised of first and second ends; wherein the first end is connected to a first furniture support assembly and the second end is connected to a second furniture support assembly; wherein at least the first end is rotatably connected.

28. The height adjustable pedestal of claim 1, wherein the first furniture support mechanism includes at least a first spindle comprised of first and second ends; wherein the first end is connected to the first furniture support mechanism, and the second end is connected to a first height adjustable column; wherein at least the first end is rotatably connected.

29. The height adjustable pedestal of claim 1, wherein the first furniture support mechanism includes at least a first spindle comprised of first and second ends; wherein the first end is connected to the first furniture support mechanism, and the second end is connected to the first furniture component; wherein at least the first end is rotatably connected.

30. The height adjustable pedestal of claim 1, wherein at least the first height adjustable telescoping column is comprised of an upper section that rotates in relationship to the lower section.

31. The height adjustable pedestal of claim 1, wherein the first and at least second base sections are connected.

32. The height adjustable pedestal of claim 1, including at least a third height adjustable telescoping column disposed above the base and supported by the base; wherein the third height adjustable telescoping column is comprised of a lower section and an upper section, wherein the upper section can move upwardly and downwardly in relationship to the lower section; wherein the third height adjustable telescoping column can be adjusted in height in relationship to the base.

33. The height adjustable pedestal of claim 32, including a third base section, wherein the third height adjustable telescoping column is disposed above the third base section; wherein the third height adjustable telescoping column is comprised of a lower section connected to the third base section, and an upper section that moves upwardly and downwardly in relationship to the lower section; wherein the third height adjustable telescoping column can be adjusted in height in relationship to the third base section.

34. The height adjustable pedestal of claim 33, wherein the third base section is connected to at least the first base section.

35. The height adjustable pedestal or claim 1, including at least a fourth height adjustable telescoping column disposed above the base and supported by the base; wherein the fourth height adjustable telescoping column is comprised of a lower section and an upper section, wherein the upper section can move upwardly and downwardly in relationship to the lower section; wherein the fourth height adjustable telescoping column can be adjusted in height in relationship to the base.

36. The height adjustable pedestal of claim 35, including a fourth base section, wherein the fourth height adjustable telescoping column is disposed above the fourth base section; wherein the fourth height adjustable telescoping column is comprised of a lower section connected to the fourth base section, and an upper section that moves upwardly and downwardly in relationship to the lower section; wherein the fourth height adjustable telescoping column can be adjusted in height in relationship to the third base section.

37. The height adjustable-pedestal of claim 36, wherein the fourth base section is connected to at least the third base section.

38. The height adjustable pedestal of claim 1, wherein the floor contacting base comprises a swivel mechanism; wherein the swivel mechanism includes an upper plate, a lower plate, and a low friction bearing assembly separating the upper and lower plates.

39. The height adjustable pedestal of claim 38, wherein the swivel mechanism further includes a frictional swivel control means for selectively controlling the ease of swivel in the swivel mechanism.

40. The height adjustable pedestal of claim 1, wherein the lower sections of the first and second height adjustable telescoping columns are connected to each other.

41. The height adjustable pedestal of claim 32, wherein the lower section of the third height adjustable telescoping column is connected to at least the lower section of at least the first height adjustable telescoping column.

42. The height adjustable pedestal of claim 35, wherein the lower section of the fourth height adjustable telescoping column is connected to the lower section of at least the second height adjustable column.

43. The height adjustable pedestal of claim 1, wherein the first furniture component is a tabletop.

44. The height adjustable pedestal of claim 1, wherein the first furniture component is a chair seat.

45. The height adjustable pedestal of claim 1, including a back support comprising slidable engagement means for providing a slidable attachment to the first furniture support mechanism.

46. The height adjustable pedestal of claim 1, including a back support attached to the first furniture component.

47. The height adjustable pedestal of claim 1, including at least first and second height adjustable telescoping columns supporting a second furniture support mechanism that is connected for slidable and pivotal engagement between a second furniture component and at least first and second height adjustable columns, wherein the at least first and second height adjustable columns are pivotally and slideably connected to the first furniture support mechanism.

48. The height adjustable pedestal of claim 47, wherein the second furniture component is a tabletop.

49. The height adjustable pedestal of claim 1, wherein the height adjustable pedestal includes at least a first electro-mechanical drive mechanism for moving the upper sections upwardly and downwardly in relationship to the lower sections of at least a first height adjustable telescoping column.

50. The height adjustable pedestal of claim 1, wherein at least a first height adjustable column includes at least a first electro-mechanical drive mechanism for moving the upper sections upwardly and downwardly in relationship to the lower sections of at least a first height adjustable column.

51. The height adjustable pedestal of claim 1, wherein the height adjustable pedestal includes at least a first piezoelectric drive mechanism for moving the upper sections upwardly and downwardly in relationship to the lower sections of at least a first height adjustable column.

52. The height adjustable pedestal of claim 1, wherein at least a first height adjustable column includes at least a first piezoelectric drive mechanism for moving the upper sections upwardly and downwardly in relationship to the lower sections of at least a first height adjustable column.

53. The height adjustable pedestal of claim 1, wherein the height adjustable pedestal includes at least a first electromagnetic mechanism for moving the upper sections upwardly and downwardly in relationship to the lower sections of at least a first height adjustable column.

54. The height adjustable pedestal of claim 1, wherein at least a first the height adjustable column includes at least a first electromagnetic mechanism for moving the upper sections upwardly and downwardly in relationship to the lower sections of at least a first height adjustable column.

55. The height adjustable pedestal of claim 1, wherein the height adjustable pedestal includes at least a first hydraulic drive mechanism for moving the upper sections upwardly downwardly in relationship to the lower sections of at least a first height adjustable column.

56. The height adjustable pedestal of claim 1, wherein at least a first height adjustable column includes at least a first hydraulic drive mechanism for moving the upper sections upwardly and downwardly in relationship to the lower sections of at least a first height adjustable column.

57. The height adjustable pedestal of claim 1, wherein the height adjustable pedestal includes at least a first mechanical drive mechanism for moving the upper sections upwardly and downwardly in relationship to the lower sections of at least a first height adjustable telescoping column.

58. The height adjustable pedestal of claim 1, wherein at least a first height adjustable column includes at least a first mechanical drive mechanism for moving the upper sections upwardly and downwardly in relationship to the lower sections of at least a first height adjustable column.

59. The height adjustable pedestal of claim 1, wherein the height adjustable pedestal includes at least a first spring drive mechanism for moving the upper sections upwardly in relationship to the lower sections of at least a first height adjustable telescoping column.

60. The height adjustable pedestal of claim 1, wherein at least a first height adjustable column includes at least a first spring drive mechanism for moving the upper sections upwardly in relationship to the lower sections of at least a first height adjustable column.

61. The height adjustable pedestal of claim 1, wherein the height adjustable pedestal includes at least a first pneumatic drive mechanism for moving the upper sections upwardly in relationship to the lower sections of at least a first height adjustable column.

62. The height adjustable pedestal of claim 1, wherein at least a first height adjustable column includes at least a first pneumatic drive mechanism for moving the upper sections upwardly in relationship to the lowers sections of at least a first height adjustable column.

63. The height adjustable pedestal of claim 1, wherein at least a first height adjustable telescoping column is disposed in a non-parallel relationship with any other height adjustable telescoping columns.
